(19) United States
(12) Patent Application Publication
(10) Pub. No.: US 2016/0032905 A1
(43) Pub. Date: Feb. 4, 2016

(54) Contact Interface Energy Harvesting Systems and Methods

(71) Applicant: Daniel KLOTZER, St. Louis, MO (US)

(72) Inventor: Daniel Klotzer, Saint Louis, MO (US)

(21) Appl. No.: 14/776,743

(22) PCT Filed: Mar. 15, 2014
(86) PCT No.: PCT/US14/30084

§ 371 Date: Sep. 15, 2015

Related U.S. Application Data
(60) Provisional application No. 61/953,709, filed on Mar. 14, 2014.
(60) Provisional application No. 61/791,431, filed on Mar. 15, 2013.

(51) Int. Cl. F03G 7/08; F04B 45/04

(52) U.S. Cl. CPC F03G 7/08; F04B 45/04

(57) ABSTRACT

The present invention is an energy harvesting contact interface usable as a vehicle tire or a cushion, among other purposes.

### CROSS-REFERENCE TO RELATED APPLICATIONS

The present application is a continuation of and claims priority to prior PCT application no. PCT/US2014/030084, filed on Mar. 15, 2014, and prior applications U.S. provisional patent application No. 61/791,431, filed on Mar. 15, 2013, and U.S. provisional patent application No. 61/953,709, filed on Mar. 14, 2014, all invented by Daniel Klotzer, and the entirety of the disclosures of the three prior applications are explicitly incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The present invention relates generally to systems and methods of harvesting energy from externally applied compressional forces, and in particular to utilizing recurrently occurring contact interface and/or compressional forces to harvest energy, said forces often acting on fluid filled (including inflated) volumes.

2. Related Art

Significant factors are increasingly raising the importance of energy production and efficiency. These factors include growing energy demands, increasing energy costs, difficulties in providing suitable energy where/when needed, and environmental impacts such as global warming One approach that can provide benefits that address all of these factors is energy harvesting, generally involving separately existing physically exploitable circumstances, to produce usable energy that would otherwise be unavailable. Among the widely implemented methods of effecting this process are hybrid automobiles that harvest energy from the braking process; energy harvesting automobile suspension shock absorbers; water wave/current driven generators, wind turbines, solar panels, and many others.

Among the factors which can influence the degree of benefit available for a given energy harvesting technique are the degree of predictability and the frequency of occurrence of the particular circumstances being exploited, as well as the technical difficulties involved in accessing and harnessing these circumstances. Examples of differing forms of predictability challenges are the differences in wind turbine generators and tidal current generators. The wind generators are powered by an inherently chaotic source, in terms of a fine grain perspective, i.e. moment to moment, one cannot predict or control the amount of wind power available at a given instant, though one can sufficiently predict the aggregate accumulation of wind power with fair reliability. The most effective winds can also present difficulties in access, (wind turbines are not constructed hundreds of feet high just to provide tall ladders to climb,) as well as difficulties in providing the energy garnered to users efficiently. The tidal generators avoid issues with predictability and often are close to users, since coastal locations usually have both the best tides and the greatest concentration of users. The tidal generators do, though, have great issues in harnessing the currents, in being properly situated, and in being sufficiently well constructed to provide lasting reliability, as any critical infrastructure must. The wind generators also present great technical hurdles, though their current evolution is more advanced than that of the tidal generators in operation and development.

A largely and at present mostly unexploited type of potential energy resource involves contact forces that affect interface(s) between physical entities. These situations include vehicle tires rolling on a road; people sitting/lying/walking on furniture/flooring; cargo and/or human transportation and/or handling; and other circumstances. In many of the existing energy harvesting schemes, including the likely most well-known implementation, at present generally termed hybrid vehicles, wherein a car is at least partially further slowed, when the brakes are applied, by expending the car's momentum to drive an inductive charging device for battery storage. This approach essentially identifies a condition that is at least temporarily undesirable and uses reduction of that condition to drive the energy harvesting. The present invention differs somewhat in that it is focused on circumstances that are largely acceptable, but are also potentially accompanied by attendant effects that may be undesirable, or are at least not of significant benefit. A prime focus of the present invention is when circumstances involve bodies which recurrently move relative to each other and wherein at least one of the bodies provides at least one form of support or cushioning to the other. Manners of harvesting energy from these situations have great potential, due to the great length of time these conditions exist (e.g. the transit time for a semi-trailer truck spent rolling on highways to bring a load cross-country,) versus the length of time that many existing hybrids can be effective (during the braking process, and no more.)

### SUMMARY OF THE INVENTION

A large variety of embodiments of the present invention are implementable, with an almost unlimited number of variations, permutations, and cross-combinations of differing aspects of other embodiments potentially integrable in other embodiments. Many embodiments employing some of the systems and methods of the present invention involve at least one fluid fillable volume which is subject to recurrent, but not generally static, boundary forcing. The volume is at least partially enclosed by a responsive boundary, wherein the term responsive indicates that the enclosing boundary is responsive to the boundary forcing and/or the boundary forcing's effect upon the fluid fill. The boundary forcing is generally driven by circumstances that exist regardless of the energy harvesting operations, though those operations can and often do transform, shape, channel, and/or communicate the forcing effect. Instances of such existing circumstances are (A) rolling cushioning bodies such as inflatable tires that provide an interface between vehicles and the surfaces they are traversing; (B) furniture, bedding, flooring, and other human supporting/cushioning surfaces which are repeatedly, though usually not only statically, utilized; (C) transportation vehicle, vessel, and plane interior interfaces between the transported contents (such as cargo, and passengers,) and the vehicle structure that imparts the transportation process dynamics to these contents; (D) Support-cushioning interfaces between people (and other animals such as horses,) and the articles they carry/support/exert force against; (E) other cushioning/supporting interfaces (such as specialized conveyor lines.)

In some of these circumstances (such as the aforementioned inflatable tires, furniture, and bedding) the cushioning support is in use (usually for reasons other than energy harvesting) prior to the introduction of embodiments of the present invention, while in other circumstances (such as an energy harvesting seat cushion for use for bouncy transits, or an energy harvesting cargo restraint,) the cushioning support is only introduced, along with the manner of its use for energy harvesting, as aspects of embodiments of the present invention. One significant consequence of this difference is that when there is a preexisting purpose for the presence of the cushioning support, additional design/implementation constraints related to the preexisting purpose for the cushioning support are likely. At minimum, it is preferred that the preexisting purpose not be less well addressed due to the introduction of the energy harvesting techniques, or the readiness of adoption can be diminished, though in certain cases the benefits of the energy harvesting can outweigh some detrimental effects. In those cases where the energy harvesting is intended to be combined with other functions that are energy consuming (such as the inflatable tire,) it is paramount that the presence of the energy harvesting produces more energy than any increase it causes in the energy consumed by the other function. The complication of this constraint is somewhat balanced by capitalizing on the accepted presence/need for the preexisting cushioning support. The complication of needing to introduce cushioning support(s) as well as embodiments of the present energy harvesting techniques where there is not an accepted presence of cushioning support, are balanced by the greater freedom from additional design constraints imposed by preexisting purposes. Another situational variation involves differences in the progression, usually over time, of the forcing effect upon the volume boundary.

In differing circumstances, the boundary forcing will manifest varying effects, though it is frequently necessary for the boundary forcing to recurrently increase and decrease (i.e. not be static.) The recurrent rising/falling boundary forcing can, depending on the circumstances, exhibit progressions that are cyclic, and/or regular (in its time progression,) and/or predictable (in how one or more attributes progress,) and/or exhibit patterns, as well as serial combinations of differing types of progressions. Additionally, the boundary forcing can manifest chaotic progressions of one or more attributes, for limited or extended periods. Differing aspects of the present invention have been variously adapted to provide capacities for energy harvesting in each of these cases, and many aspects are suited for boundary forcing circumstances that exhibit varying degrees of order as well as differing progressions. In most cases, greater energy harvesting efficiency can be achieved when a specific embodiment is customized to a specific set of circumstances, while in other cases the benefits of wider applicability will outweigh the potential rise in efficiency. Frequently, more specifically adapted embodiments are preferable in the afore mentioned situations wherein a supporting cushion is already present, since the circumstances of use in such cases tend to be more predictable.

A first genre of the present invention's energy harvesting techniques, referred to herein as rotary techniques, include a nearly ubiquitous pre-existing cushioning support: inflatable tires. (It should be understood that the following description of the present invention's rotary energy harvesting techniques are described primarily in regard to inflatable tires for purposes of descriptive clarity enhanced by a unity of described implementation, however most of the aspects of these rotary techniques are equally applicable to most any other form of inflatable, rotating cushions and/or supports, including those that may involve purely oscillating, or even chaotic cushioning motions such as boat fenders or motion isolators.) Vehicle tires commonly comprise a primary supporting interface, the tire tread, and an inflated bladder portion, which is sometimes constructed as an integrated part of the tire exterior but is also often a separate inner tube component. The tires must satisfy a number of performance criteria since, collectively, they are the entire interface between the vehicle and the surface it crosses. Preferably, tire embodiments of the present invention are constructed so as to provide their energy harvesting benefits without comprising the tires' capacities to realize the performance criteria. When a tire utilizes an inner tube construction, the energy harvesting embodiments implemented need to achieve limited numbers of constraints, primarily a spatial configuration fit and appropriate pressure maintenance. Tire exteriors integrated with the inflatable bladder present both greater ranges of energy harvesting techniques that can be employed (because energy harvesting techniques which also utilize the tire exterior are then available,) as well as greater potential complications, since an integrated energy harvesting bladder embodiment has the same constraints as the inner tube embodiments, but also must accommodate the additional ranges of constraints required of tires, such as vehicle cornering control, roadway traction maintenance, road surface imperfection adjustment, durability, and so on.

The common denominator among tire types is the need to maintain traction with the road, and its imperfections, while cushioning the vehicle from the physical consequences of the contact with the road surface at speed. The pliability and shock absorption of inflatable bladders has made them virtually irreplaceable, but at costs including inefficiencies due to energy lost in constantly deforming the tire and its contents, since the portion of the tire directly between the road surface and the vehicle is squeezed and then released once the wheel rotates, and the bladder's entire fluid contents are continuously churned by the movement of the altered cross-section portion about the tire's extent. Differing aspects of the present invention provide various capacities for energy harvesting by utilizing one or more of (a) the interior fluid pressure dynamics forced by the bladder's rotating configuration change (when the vehicle is in motion;) (b) the tire exterior material's deformation dynamics; (c) the inflatable interior's cross-section squeezing dynamics; While all three of these usually work in concert to support and cushion the vehicle's movement, and are difficult to definitively separate in effect for that purpose, when energy harvesting they must be considered separately, since they are regularly not optimally addressed with a uniform approach. Approaches (b) and (c) offer superior capacities when implemented with an integrated bladder tire, while approach (a) provides significant capacities both with inner tubes and integrated bladder tires, and hence is described first.

When a standard vehicle tire is properly inflated, the portion of the tire actually in contact with the road, generally referred to as the contact patch, represents only a small fraction of the tire's tread surface. The radial section of tire that includes the contact patch has an interior configuration that is compressed, relative to when that section does not include the contact patch. A portion of the tire's fluid (air) fill that would otherwise be contained in a given radial section is displaced when that section includes the contact patch. Prior to now, the displaced fluid was left to interact chaotically with the rest of the tire interior's fluid fill, frequently resulting in unproductive heat generation and definitely not energy useful for doing work. Some aspects of the present invention introduce constraints upon the movement of the tire interior's fluid fill, and then harvests energy from the fluid motion driven by the contact patch's cycles of compression/decompression. Often, the tire interior is at least partially subdivided, so that movement of the fluid fill or pressure waves within the fill are at least partially constrainable and/or controllable, frequently with fluid channeling. (In the remainder of the present application, unless specifically indicated otherwise, it should be understood that references to utilizing the fill ‘fluid’ to harvest energy can refer to utilizing one or more of the movement of the fluid fill, the movement of pressure waves in the fluid fill, and/or effects caused by the fluid fill dynamics induced by the rotating contact patch and its attendant circumstances such as a rotating—relatively—direction of gravity.) The at least partial control of these fluid effects enable the effects to be utilized to do work, which can produce net positive energy production including increases, if any, in the work required to turn the wheel and tire. In some embodiments it is possible for implementations of the present invention to even be developed into systems that can actively reduce either or both of a tire's rolling friction as well as mitigating or reducing other transportation related energy consumptions such as energy lost in cornering. By differentially controlling the dynamics of a vehicle's tires on the inside of a turn vs. the outside of a turn, a portion of the energy lost in turning is capturable as well. Even further benefits in augmenting braking as well as using energy harvesting when braking are implementable by tuning the rate of work-producing-deflation of a tire section that is about to become the contact patch. Just as a deflated tire slows a car, a more aggressive deflation of the section becoming the contact patch will both slow the vehicle and allow that additional deflation effect to be captured as harvested energy. Additional advances in energy harvesting will also be achievable by continuously tuning the tire's capture process to adapt to varying dynamic situations.

A variety of tactics are employable to effect the constraining and/or controlling of the fluid fill, as well as the harvesting of energy form the fluid, and differing aspects of the present invention will employ differing implementations depending on the circumstances of their use, and it is within the scope of the present invention for one or more tactics to be utilized within a single implementation. A first aspect of the fluid constraining process involves dividing the fluid bladder into a plurality of segments that can vary in size, spatial disposition, border attributes (i.e. resilient vs. rigid & movable), and interrelations. In general, the cycles of compression/decompression will exert recurrent forces on the fluid fill, usually causing it to flow and/or produce pressure waves that are then harvested to produce energy. Inflatable tires are generally designed to resiliently cycle between compression/decompression in order to cushion road shocks, compensate for roadway defects, and improve traction. These cycles dissipate at least a portion of the work expended in turning the tires (various estimates of the energy cost of the tires' rolling resistance vary from 10-25% of the total fuel cost expended in moving the vernicle.) Many embodiments of the present invention are tunable so that they can maximize their capture of the energy expended in overcoming the rolling resistance without adding to it. Most are capable of capturing at least some of the rolling resistance energy without increasing the rolling resistance, and some may even be able to reduce the rolling resistance as well as capture energy from the remainder of the rolling resistance. In addition, certain embodiments are variably operable so that their efficiency can be tuned on the go, some are even tunable automatically and/or autonomously. The manners by which this is accomplished will vary according to the details of the embodiment's construction, as well as the conditions of use. One significant technique capitalizes on the inherent need for a base level of compression resistance in a tire for it to accomplish its purposes. Some embodiments of the present invention are also constructed to closely tailor their operation to effectively mimic the compression performance of existing tire systems to avoid compromising the tire's ability to perform its cushioning, handling, and stability functions; as well as to enable a ready introduction of the present invention with existing vehicle tire systems.

The fluid flow and/or pressure waves created within the tire are controlled to drive one or more transitioners. As used herein, transitioner is a term that denotes an element which transitions one form of motion, force, or action, to another, such as a gearing turning a linear input into a rotational output. In many case, a transitioner will also be able to function as a transducer, and in certain cases the difference between a transitioner and a transducer can be as much a matter of classification as structure. The form of transitioner and the manner in which it is driven are widely variable, depending on a variety of factors, including the form of vehicle and type of tire employed, the situation of use and the manner of utilization, the preference between reduced initial equipment cost and increased end-total energy harvested, the longevity intended and the degree of efficiency, as well as other factors. Certain commonalities will be frequently recurrent, though sometimes in differing forms, including that the fluid flows will be regularly channeled so that the flow drives a transitioner element, such as a propeller, connected to an electromagnetic generator; or a flap covered port wherein the flap is constructed or interrelated with a piezoelectric material, such as Polyvinylidene fluoride (PVDF) that generates an electric potential when appropriately stressed, so that when the fluid flows it bends the flap thereby stressing the PVDF to generate electricity. The pressure waves will be regularly directed to exert force on a surface that responds to the pressure fluctuations, for example, by being moved or being stressed. When a movement is caused, that movement is either directly utilized to power a generator component (such as a bladder surface driving a magnetic element back and forth through wire coils) or can be utilized to indirectly generate power (such as a resilient bladder surface regularly compressing/decompressing an adjacent fluid chamber that is then used to generate harvestable power.)

A second genre of energy harvesting techniques, referred to herein as auto-reverting techniques, involve at least first and second fluid fillable volumes in fluid communication with each other. The first volume is often at least partially enclosed by a first envelope, which is often at least partially pliable enough to be ductile when subjected to sufficient boundary forcing, and is also often resilient. The resiliency is usually sufficient to assist the first volume envelope to at least partially resume an initial, uncompressed configuration once the boundary forcing is sufficiently diminished, though in certain embodiments the restoration of the initial configuration is enacted via ambient factors and/or fluid flow/pressure wave forcing. A second envelope enclosing the second volume is also sometimes resilient, but the second envelope is less pliable than is the first envelope, so that the second volume expands distinctly less than does the first volume when both are subject to the same increase in internal fluid pressure. Similarly, when the two volumes are subject to the same boundary forcing, the first volume will be compressed more than the second volume due to the differences in the two envelopes. When the two volumes are in fluid communication, the fluid flow can be channeled to drive a transducer and power can thereby be harvested. Alternatively, the pressure waves can be harnessed, for example, to drive a membrane that powers a transducer.

It should be understood that all of the various aspects and embodiments of the present invention, as well as their various sub-components are shown as illustrative examples and are not limiting. Any portion of any aspect of the present invention can also include any other portion of any other aspect where warranted. These include matters such as substituting inflated channels to translate force for pulley lines, or swapping multiple generators for a single centralized generator. The means of translating forces and other dynamics, as well as approaches for translating these forces into electricity (or other forms of energy,) are well known and while employed herein, the detailed constructions of each and their alternatives are referred to, but not greatly detailed since they are so well known. Additionally, the uses of the energy harvested, and the means of translating/storing that energy, such as batteries and induction plates, are also well known and though they are relevant, they are also not detailed explicitly in depth herein also because they are so well known and their specific manners of operation are used but not greatly further developed herein.

A first representative aspect of the second genre comprises a plurality of such paired first and second volumes, enclosed by first and second envelopes, respectively, integrated into a cushioning support such a seat cushion. The paired volumes may each drive separate transducers or may work cooperatively wherein multiple pairs collectively drive a single transducer. Frequently, the first envelope is in primary contact with an interface, such as a seat surface, while the second volume is in fluid communication with the first volume, and often the second envelope is in immediate contact with the first envelope as well. The first envelope/volume arrangement is usually more easily compressed than the second envelope/volume arrangement, and upon sufficient compression force the first envelope/volume may even recess at least partially into the second envelope/volume. The movement of the fluid fill from first to second (as well as optionally also from second to first,) volumes is then channeled through a transducing element such as a propeller/generator configuration so that energy is harvested, and then used or stored. Because the second envelope's compression resistance is greater than that of the first envelope, when the external compression force is alleviated, such as when a vehicle bounces on a road, the first envelope/volume is forced to re-expand, and is then ready again for the next cycle of compression/decompression. A spring, or the like, may also be used to augment the re-expansion. Furthermore, a plurality of these first and second envelope/volumes can be interrelated so that compressions of one of these elements can also re-expand a different first envelope/volume of a different element. Not only can each individual element harvest energy, but the interrelations can also be configured to harvest energy. In this way, for example, a sleeping mat can harvest energy from normal movements and/or even breathing to harvest energy.

Major varieties of additional functionalities are provided by the embodiments of the present invention that include various forms of active treads. In addition to the ability to reduce the energy losses due to tire tread hysteresis, for example, by constructing the tread of tread segments that are able to move freely relative to each other, subject to the constraints of the application. In addition to avoiding the losses of hysteresis, the active tread segments provide another means of using the contact with the roadway to drive energy harvesting mechanisms, by channeling the forces that drive the tread hysteresis losses instead into the inputs of mechanisms which provide resistance by causing the movement of the tread segments to do work. This work is in turn used to generate electricity, either directly or indirectly. These mechanisms are able to work in differing embodiments with a large range of sizes and disposition spaces. They can be used in any number of combinations, and in varying arrangements so that forces pressing on any portion of a contact interface such as a tire tread can be harnessed, including forces produced by turning, roadway surface variations, and braking, in addition to the forces generated by standard straight line operations. Also, it should be understood that just as any of these active tread segment embodiments, irrespective of the number of active layers, can be used to generate electricity by harnessing forces incident upon the tread and/or tire interior, reversing the flow of electricity can switch these force harnessing mechanisms into force producing mechanisms, which can drive, turn, stabilize, and brake the vehicle. Other objects and features will be in part apparent and in part pointed out hereinafter. Among the representative claim for the present invention, though not limiting in any way of the other potential claims that fall within the scope of the present invention, is a claim to an energy harvesting tire:

A energy harvesting tire suited for disposition upon a vehicle wheel, comprising:
An inflatable closed toroidal surface structure enclosing an air volume with an exterior roadway contact surface suitable for disposition as a rolling vehicle support;
said tire sub-divided into at least first and second portions such that the roadway contact and vehicle load bearing forces that impact upon the first portion are significantly different than those that impact upon the second portion, and at least a first harnesser of the tire-portion-impacting-forces which is driven by said impacting force differences between the first tire portion and the second tire portion.

### BRIEF DESCRIPTION OF THE DRAWINGS

FIG. 1 depicts a cross-section view of a legacy tire and wheel construction.

FIG. 2 depicts a combination perspective and cross-section view of a legacy tire and wheel construction.

FIG. 3 depicts a cross-section view of a first membrane aspect of the present invention.

FIG. 4 depicts an expanded detail cross-section view of a portion of a first membrane aspect of the present invention.

FIG. 5 depicts a cross-section view of a first articulating aspect of the present invention.

FIG. 6 depicts a cross-section view of a second articulating aspect of the present invention.

FIG. 7 depicts an expanded detail cross-section view of a first portion of a first membrane aspect of the present invention.

FIG. 8 depicts an expanded detail cross-section view of a second portion of a first membrane aspect of the present invention.

FIG. 9 depicts an expanded detail cross-section view of a third portion of a first membrane aspect of the present invention.

FIG. 10 depicts a cross-section view of a sidewall constraining aspect of the present invention.

FIG. 11 depicts a cross-section view of a second membrane aspect of the present invention.

FIG. 12 depicts an expanded detail cross-section view of a first portion of a second membrane aspect of the present invention.

FIG. 13 depicts an expanded detail cross-section view of a second portion of a second membrane aspect of the present invention.

FIG. 14 depicts an expanded detail cross-section view of a third portion of a second membrane aspect of the present invention.

FIG. 15 depicts a cross-section view of a first partitioned aspect of the present invention.

FIG. 16 depicts an expanded detail cross-section view of a first portion of the first partitioned aspect of the present invention.

FIG. 17 depicts a further expanded detail cross-section view of a second portion of the first partitioned aspect of the present invention.

FIG. 18 depicts a cross-section view of a third membrane aspect of the present invention.

FIG. 19 depicts an expanded detail perspective view of a first alternative portion of the third membrane aspect of the present invention.

FIG. 20 depicts an expanded detail perspective view of a second alternative portion of the third membrane aspect of the present invention.

FIG. 21 depicts a combined perspective and cross-section view of a first tire and inner tube aspect of the present invention.

FIG. 22 depicts a perspective view of a first auto-reverting aspect of the present invention.

FIG. 23 depicts a perspective view of an operating first auto-reverting aspect of the present invention.

FIG. 24 depicts a perspective view of a plurality of arranged first auto-reverting aspects of the present invention.

FIG. 25 depicts a side cross-section view of aspects of a first segmented-tread embodiment of the present invention.

FIG. 26 depicts an expanded detail cross-section view of a first hetero-directional gear aspect of the first segmented-tread embodiment.

FIG. 27 depicts an expanded detail cross-section view of a second hetero-directional gear aspect of the first segmented-tread embodiment.

FIG. 28 depicts a side cross-section view of aspects of a second segmented-tread embodiment of the present invention.

FIG. 29 depicts a side cross-section view of aspects of a third segmented-tread embodiment of the present invention.

FIG. 30 depicts an expanded detail cross-section view of a representative portion of a first geared-pulley aspect, suitable for inclusion in any of the first, second and third segmented-tread embodiments, as well as a multitude of other embodiments of the present invention; disposed in a first, early drive stroke disposition.

FIG. 31 depicts an expanded detail cross-section view of a representative portion of a first geared-pulley aspect, suitable for inclusion in any of the first, second and third segmented-tread embodiments, as well as a multitude of other embodiments of the present invention; disposed in a second, late drive stroke disposition.

FIG. 32 depicts an expanded detail perspective view of a first raceway aspect suitable for inclusion in a multitude of embodiments of the present invention.

FIG. 33 depicts an expanded detail cross-section view of the first raceway aspect of the present invention.

FIG. 34 depicts a cross-section view of a representative portion of a scissor-arm modular embodiment of the present invention, in an extended disposition.

FIG. 35 depicts a cross-section view of a representative portion of a scissor-arm modular embodiment of the present invention, in a compressed disposition.

FIG. 36 depicts a cross-section side view of a representative portion of a first modular tread arrangement suitable for a number of modular embodiments of the present invention.

FIG. 37 depicts a cross-section side view of a representative portion of a first linear shuttling tread segment arrangement and a second geared pulley aspect of a first shuttling tread embodiment of the present invention.

FIG. 38 depicts an expanded detail cross-section view of the second geared pulley aspect and a portion of its spatial interrelation with a first shuttling tread segment along with their interrelation with a raceway aspect when the first shuttling tread segment is in a first disposition.

FIG. 39 depicts an expanded detail cross-section view of the second geared pulley aspect and a portion of its spatial interrelation with a first shuttling tread segment along with their interrelation with a raceway aspect when the first shuttling tread segment is in a second disposition.

FIG. 40 depicts a cross-section side view of a representative portion of a first eccentrically reciprocating cam and segmented-tread embodiment of the present invention.

FIG. 41 depicts a composite detail cross-section side view of a number of relative dispositions that can be assumed by one of the eccentrically reciprocating tread segments.

FIG. 42 depicts a cross-section side view of a representative portion of a second eccentrically reciprocating cam bi-layer segmented-tread embodiment of the present invention.

FIG. 43 depicts a cross-section side view of a representative portion of a first arm and cam modular embodiment of the present invention.

FIG. 44 depicts a cross-section side view of a representative portion of a second arm and cam modular embodiment of the present invention.

FIG. 45 depicts a cross-section side view of a representative portion of a first arm and slot modular embodiment of the present invention.

FIG. 46 depicts a cross-section side view of a representative portion of a first traveling transducer aspect included in a first non-linear shuttling tread segment embodiment of the present invention.

FIG. 47 depicts a cross-section side view of a representative portion of a second traveling transducer aspect included in a second non-linear shuttling tread segment embodiment of the present invention.

FIG. 48 depicts a cross-section side view of a representative portion of a single geared, dual cam modular embodiment of the present invention in an uncompressed disposition.

FIG. 49 depicts a cross-section side view of a single geared cam modular embodiment of the present invention in a compressed disposition.

FIG. 50 depicts a cross-section side view of a representative portion of a fluid mediated (including optional bearings) transitioner aspect included in a third non-linear shuttling tread segment embodiment of the present invention.

FIG. 51 depicts a cross-section side view of a representative portion of a first pendulum arm embodiment of the present invention.

FIG. 52 depicts an expanded detail cross-section view of an alternate pendulum arm and geared cam transitioner aspect of the first pendulum arm embodiment of the present invention, in a post-work phase disposition.

FIG. 53 depicts an expanded detail cross-section view of an alternate pendulum arm and geared cam transitioner aspect of the first pendulum arm embodiment of the present invention, in a pre-work phase disposition.

FIG. 54 depicts a cross-section side view of a representative portion of a second pendulum arm embodiment of the present invention.

FIG. 55 depicts a cross-section side view of a representative portion of an asymmetrical dual-cam embodiment of the present invention.

FIG. 56 depicts an expanded detail view of a dual cam aspect of the asymmetrical dual cam embodiment of the present invention, in a pre-work phase disposition.

FIG. 57 depicts an expanded detail view of a dual cam aspect of the asymmetrical dual cam embodiment of the present invention, in a post-work phase disposition.

FIG. 58 depicts a cross-section side view of a representative portion of a third pendulum arm embodiment of the present invention.

FIG. 59 depicts a cross-section side view of a representative portion of a fourth pendulum arm embodiment of the present invention.

FIGS. 60a & 60b depict side views of extended and compressed dispositions, respectively, of a first dual reverse pendulum embodiment of the present invention.

FIG. 61 depicts an expanded detail side view of a tri-cog pulley aspect of the first dual reverse pendulum embodiment of the present invention.

FIG. 62 depicts a cross-section side view of a representative portion of a first slotted co-pivoting interrelated tread segments embodiment of the present invention.

FIGS. 63a & 63b depict side views of a compressed disposition first post and reciprocating barrel embodiment, and an extended disposition post and reciprocating barrel transitioner aspect of the first post and reciprocating barrel embodiment, respectively, of the present invention.

FIG. 64 depicts a cross-section side view of a tread and transitioner portion of a second post and reciprocating barrel embodiment of the present invention.

FIG. 65 depicts an expanded detail cross-section view of a third post and reciprocating barrel transitioner aspect of the present invention.

FIGS. 66a & 66b depict cross-section side views of a fourth post and reciprocating barrel embodiment of the present invention in extended pre-work phase and compressed post-work phase dispositions, respectively.

FIG. 67 depicts a perspective view of a portion of a first multi-geared transitioner arrangement suitable for inclusion in the fourth post and reciprocating barrel embodiment of the present invention.

FIG. 68 depicts a perspective view of a transitioner aspect portion of a first sleeved gear embodiment of the present invention.

FIG. 69 depicts a cross-section side view of a second transitioner aspect portion of a second sleeved gear embodiment of the present invention.

FIG. 70 depicts a cross-section side view of a third transitioner aspect portion of a third spiral sleeved gear embodiment of the present invention.

FIG. 71 depicts a perspective view of a first reciprocating cam embodiment of the present invention.

FIG. 72 depicts a second orientation option for a first cam transitioner aspect of the first reciprocating cam embodiment of the present invention.

FIG. 73 depicts a perspective view of a second reciprocating cam embodiment of the present invention.

FIG. 74 depicts a first bellows embodiment of the present invention.

FIG. 75 depicts, from left to right, compressed and extended disposition cross-section views of a first bellows transitioner aspect of the first bellows embodiment of the present invention.

FIG. 76 depicts a cross-section view of a first shape-shifting pressurizer embodiment of the present invention, in non-load bearing disposition.

FIG. 77 depicts a cross-section view of the shape-shifting pressurizer embodiment of the present invention, in a load bearing disposition.

FIG. 78 depicts an speculative composite cross-section view of the internal shape-shifting pressurizer aspect of the shape-shifting pressurizer embodiment of the present invention, in a load bearing disposition, superimposed on the periphery of the tire interior in a non-load bearing disposition.

FIG. 79 depicts an speculative composite cross-section view of the internal shape-shifting pressurizer aspect of the shape-shifting pressurizer embodiment of the present invention, in a non-load bearing disposition, superimposed on the periphery of the tire interior in a load bearing disposition.

FIG. 80 depicts a cross-section view of a first rotating partitions embodiment of the present invention, in a non-load bearing disposition.

FIG. 81 depicts a cross-section view of a first rotating partitions embodiment of the present invention, in a load bearing disposition.

### DETAILED DESCRIPTION OF THE PREFERRED EMBODIMENTS

In the following description, identical numbers indicate identical elements. Where an element has been described in one Figure, and is unaltered in detail or relation in any other Figure, said element description applies to all Figures. In most of the descriptions of the embodiments, the drawings should be considered as schematic and not necessarily describing dimensions to scale or realistic detail, unless the description specifically and expressly does describe exact dimensions, relative dimensions, or particular details.

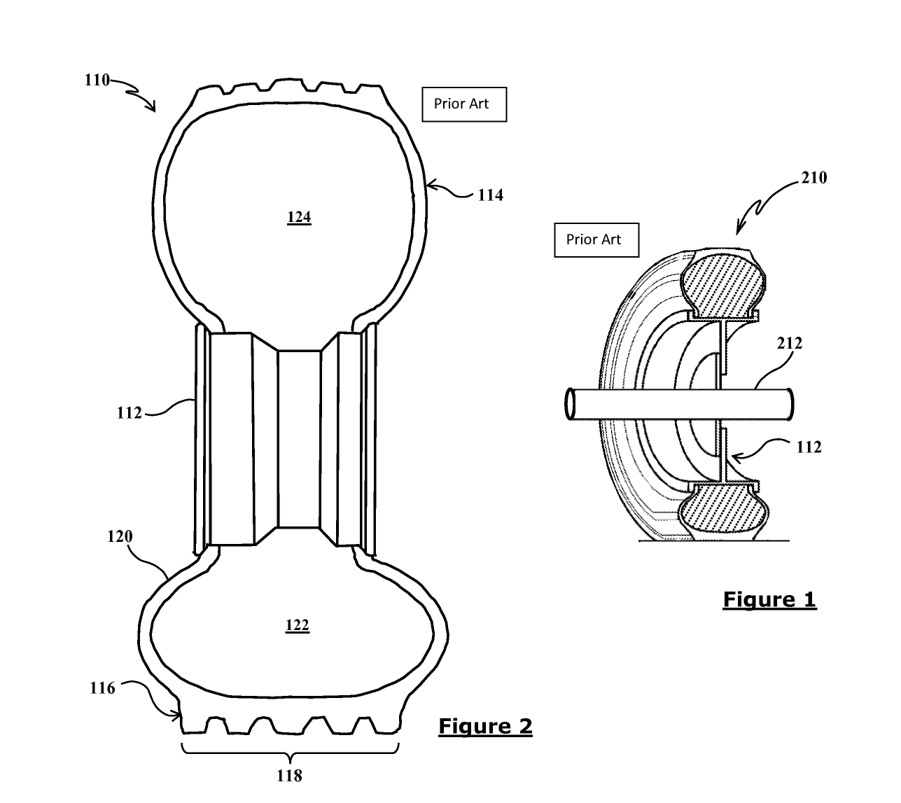

In FIG. 1 is depicted a cross-section view of a typical legacy tire 110 construction showing a wheel 112 and a tire 114. The tire 110 rides on a tread 116 that, when a contact patch 118 portion of the tread 116 is forced towards the wheel 112 compresses and alters the cross-section of the supporting tire section volume 122, as compared to a non-supporting tire section volume 124. The supporting volume 122, in comparison to the non-supporting volume 124, has a more flattened profile and will contain less interior space per degree of arc about the tire. In FIG. 2 is depicted a perspective view 210 of a similar tire construction showing further details of one manner of interrelationships of the wheel 112 and a schematically shown axle 212. The difference in absolute height between the wheel 112 and the tread contact patch 118 is seen to be, for quick estimation's sake, 2 centimeters while the weight of an almost typical car can be taken to be 2000 kilos. Hence, a substantial amount of work is being done on the supporting section of the tire (2000 kilos weight divided by four tires,) yet the tire is only flattening by a matter of centimeters. These significant forces are the power source for the energy harvesting of some aspects of the present invention. Various aspects of the present invention are implementable in varying ways, with varying degrees of integration of the inner tube, tire, and wheel. Greater degrees of integration of the tube/tire/wheel into a given implementation of the energy harvesting aspects of the present invention, while providing increasing degrees of capabilities, do not preclude inclusion also of aspect portions, features, and/or techniques utilized in a less integrated implementation. For example, a stand-alone technique (i.e. used without any other energy harvesting technique,) of harvesting energy from channeled air flow within a tire inner tube can also be used in a fully integrated tube/tire/wheel implementation, as well as vice a versa. Hence, while many of the present invention's aspects and techniques described herein are generally shown in one implementation with one degree of integration of the tube/tire/wheel, it should be understood that these are merely illustrative representations, and that the scope of the present invention includes a full range of assortments and combinations of these aspects and techniques.

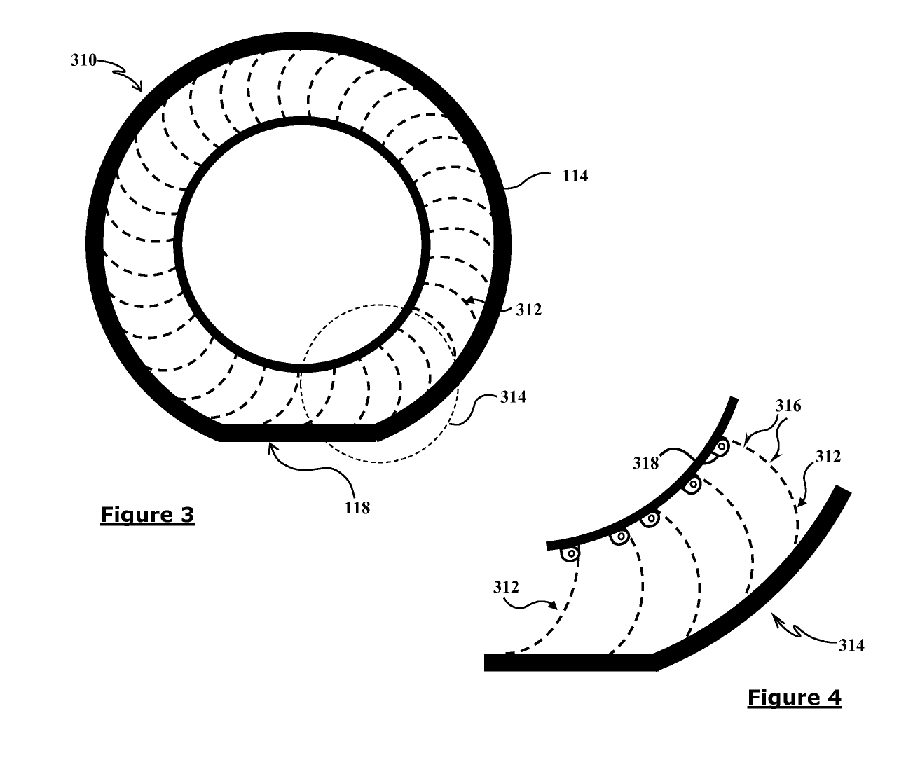

A cross-section view of a first aspect of the present invention is shown in FIG. 3 wherein an inner tube 310 (that fits into the tire 114—not shown—the tire 114 rides on the contact patch 118. The interior volume of the inner tube 31 is subdivided by a plurality of dividing membranes 312. The region with the dashed circle 314 is seen in more detail in the expanded section view of FIG. 4, which shows the membranes 312 perforated by a plurality of pores 316. The specifics of the number, sizes, uniformity, distribution, and shapes of the pores 316 are essentially unlimited, with any or all of these open for manipulation to accomplish particular tuning objectives. In the present embodiment, the membranes 312 are at least somewhat pliable, perhaps resilient or even highly stretchable. In this case the inner tube 310 is rolling from left to right. The membranes 312 impede the anti-clockwise flow of air around the tire as the contact patch 118 migrates, with the pores 316 allowing selective amounts and types of airflow. As the airflow presses on the membranes 312, the air flow exerts force on the membrane 312, bowing them and pulling on their anchors to the inner tube 310. An interior attachment end of the membrane 312 is interrelated with a transitioner and/or gearing 318 which is able to convert the membrane 312 pulling force into usable energy, or translates the force through a medium to a transducer which does convert the force into usable energy. The membranes 312 can also be rigidly shaped, as well as shaped in flow shaping manners (i.e. shaped in manners that are not responsive, or even opposite of the manner that the flow would shape them.) The transducer 318 could also be on the outer membrane attachment end, though it is considered often more likely to produce an efficient construction to locate them on the inside.

The form of the transducer (or gearing) 318 can have any suitable well known form, and the translation medium can be electrical wires, pulley lines, another extended gearing, fluid channels, or any other suitable form.

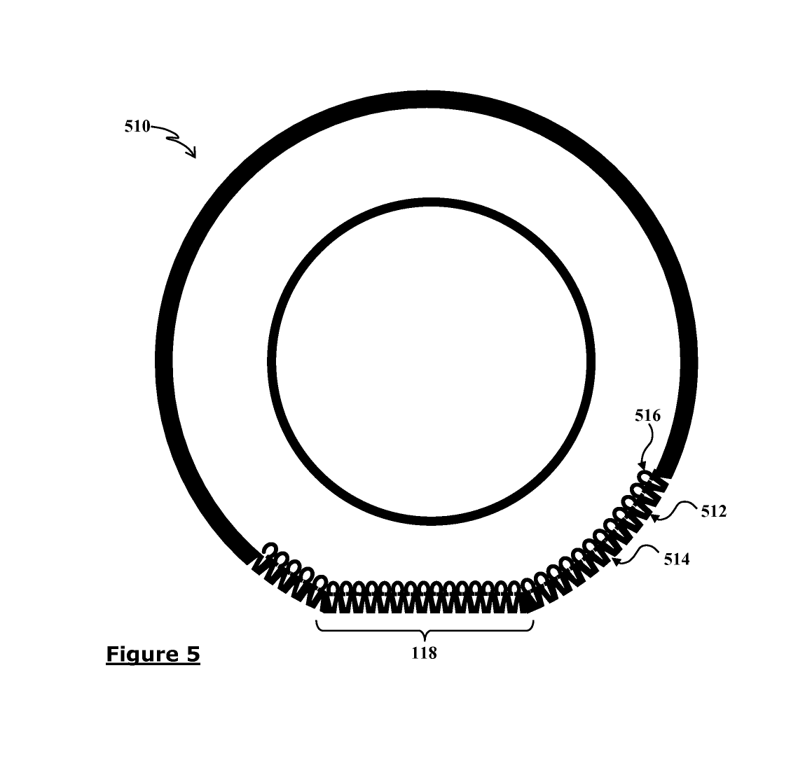

A first articulating tire tread 510 construction is depicted in FIG. 5. In addition to their capacity to generated harvested energy, certain aspects of the present invention also address another complication of moving vehicles on tires, and that is the resistance of the tire material itself to the physical manipulations required to force it to assume the contact patch 118 configuration. The very same portion of the tire 510 that must be thick to provide toughness and wear life, the tread 116, is also the portion which undergoes some of the more radical deformations in shape. To alleviate these energy costs of turning the tire when under load the tread 116 is provided an articulating construction wherein the exterior shell 512 has an undulating, or zigzag, construction to provide less energy-costly ranges of motion. A plurality of insets 514 are spaced on both the external and internal surfaces of the shell 512 to provide both a tread pattern and enhanced ease of folding/unfolding. A complementary array of co-articulating members 516 interrelate the internal peaks of the shell 512 as either or both an augmentation of the shell 512 folding/unfolding and/or as components which can be used to again drive, either directly or indirectly, transducers for energy harvesting. Alternatively, the co-articulations can contain folding/unfolding enhancing mechanisms should it be determined for a given implementation that that would be of greater overall energy benefit. It should be understood as well that the form of articulating shell shown in FIG. 5 is illustrative and essentially any form of construction providing for such articulating, whether actively controlled or passively enacted by ambient condition is within the scope of the present invention.

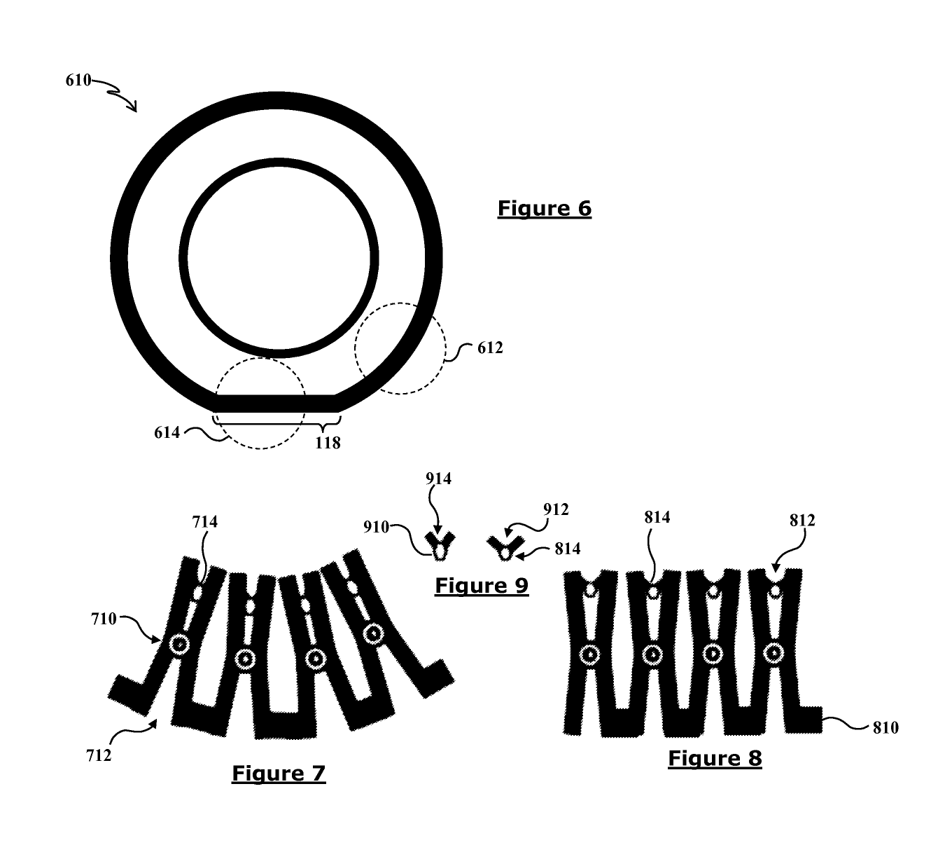

FIGS. 6-9 depict a second articulating tire tread 610 construction. FIG. 9 is an expanded detail view of the region in the dashed circle 612 wherein the articulating tire tread 610 is in the arrangement it assumes when not in the contact patch 118, and FIG. 7 is an expanded detail view of the region in the dashed circle 612 wherein the articulating tire tread 610 is in the arrangement it assumes when in the contact patch 118. The articulating tire tread 610 is composed of pseudo U-shaped tread segments 810 which are joined to an adjacent segment 810 at a rotating junction 710. The rotating junctions 710 themselves can be passively operative, energy harvesting, or forced, depending on the circumstances, though in the present case they are essentially free rotating, under the influence of the other aspects of the tire's operations. A series of outer splits 712 and inner splits 812 separate the adjacent inner and outer ends, respectively, of each adjacent pair of the segments 810, with the outer spits 712 being greater, and correspondingly the inner splits 812 being lesser, when the tire portion is not in the contact patch 118, as shown in FIG. 7, and vice versa when the tire portion is in the contact patch portion 118, as shown in FIG. 8. By configuring the rotating junction 710 to freely rotate, the articulating tire tread 610 can be constructed to passively provide lesser resistance to the tread deformations when the articulating tire tread 610 is rolling under load. Alternatively, a piezo-electric actuated hinge 814, shown in expanded detail in FIG. 9, can be arranged between the adjacent inner arms of adjacent segments 810. The piezo-electric actuated hinge 814 is composed of a piezo-electric actuator 910 that, depending on the manner of utilization, can be arranged to cause either widened arms 912 or narrowed arms 914, when receiving an electric current, and vice versa when producing an electric current. One particularly advantageous arrangement involves arranging an electric interconnection between the piezo-electric actuated hinge 814 that is entering the contact patch 118 and the piezo-electric actuated hinge 814 that is simultaneously leaving the contact patch 118. The piezo-electric actuated hinge 814 hinge leaving the contact patch 118 is arranged to produce electric current in response to the forcing outward of the adjacent segments 810 responding to the tire resuming its extended form which in turn disposes the piezo-electric actuated hinge 814 in the widened arms 912 arrangement. The current produced by the contact patch 118 leaving piezo-electric actuated hinge 814 is routed to the contact patch 118 entering piezo-electric actuated hinge 814 which is arranged to cause the narrowed arms 914 configuration, thereby also causing the adjacent segments 810 to assume the contact patch 118 disposition.

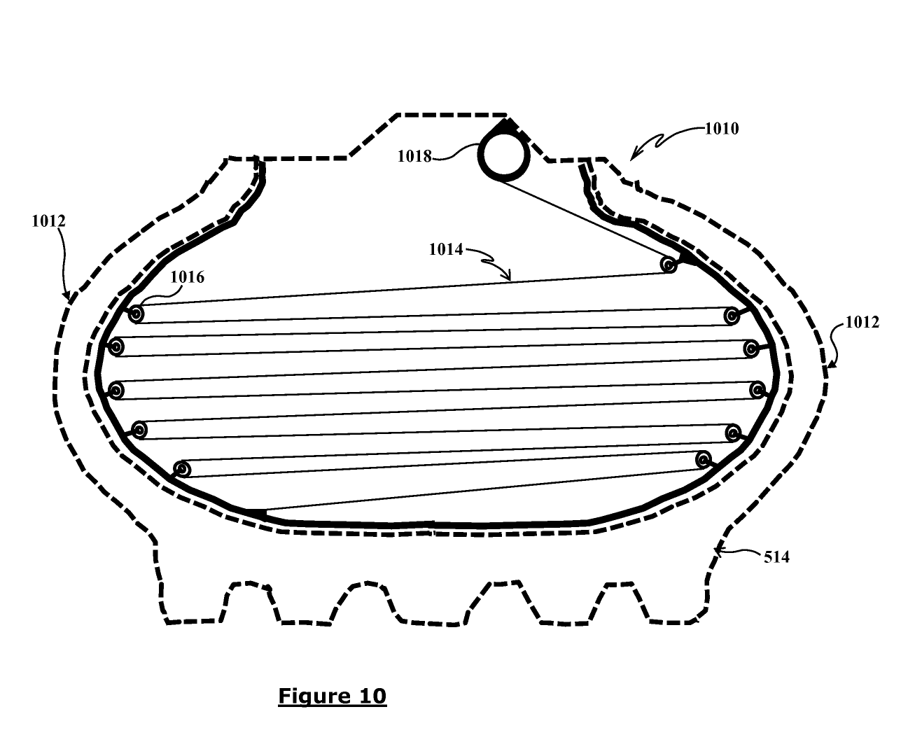

A sidewall constraining aspect 1010 shown in FIG. 10 is driven by the outward forcing of the tire sidewalls 1012 when that portion of the tire is the contact patch. Within the tire volume is arranged a series of tire width crossing lines 1014 that run between pulleys 1016. As the tire sidewalls 1012 are forced apart, the lines 1014 are pulled and the force they translate is harvested by the generator 1018. The specific arrangement depicted in FIG. 10 is illustrative only, and not limiting. The cross-section view of FIG. 10 shows a configuration that can be packaged into a slice like cross-section which can then be radially spaced about the tire/inner tube interior. Many alternative arrangements of lines, pulleys, and generators also fall within the scope of the present invention, including essentially any manner of using the forcing apart of the sidewalls when at the contact patch to drive a generator.

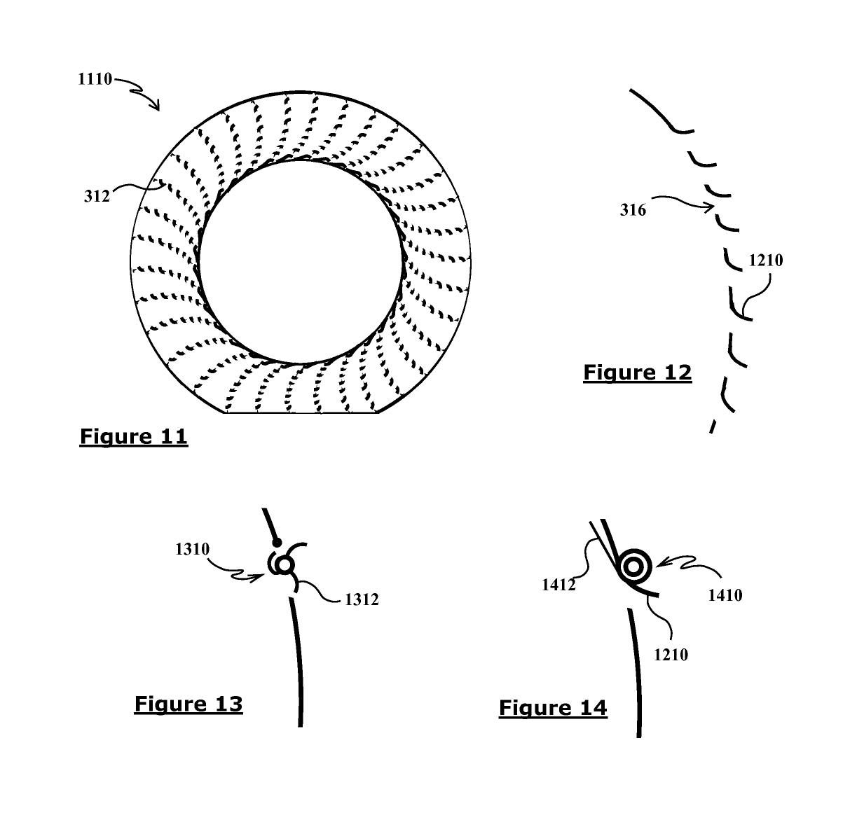

FIGS. 11-14 show a second membrane employing aspect 1110 of the present invention, wherein now the membranes 312 are also perforated, and disposed at the pores are arrays of energy harvesting mechanisms 1310 or 1410. The particular implementations of the energy harvesting mechanisms 1210 and 1410 depicted in FIGS. 13 and 14 are only illustrative and not limiting, and as before, essentially any form of transducer arrangement is alternatively utilizable. In the second membrane employing aspect 1110 the pores 316 are obstructable by flaps 1210 which hinge at their connection to the membranes 312. The flaps 1210 can be part of a rotating assembly 1310 which can also include flexible flaps 1312 which extend and fold to further improve the rotational responsiveness of the rotating assembly 1310. As the air is force threw the pores 316 the flaps 1312 drive the rotation, which is then coupled to another transducer arrangement as discussed before. Alternatively, the hinging flap 1210 can, by an oscillating gearing arrangement, be used to drive a line 1412 which in turn, directly or indirectly, drives a transducer arrangement to harvest energy.

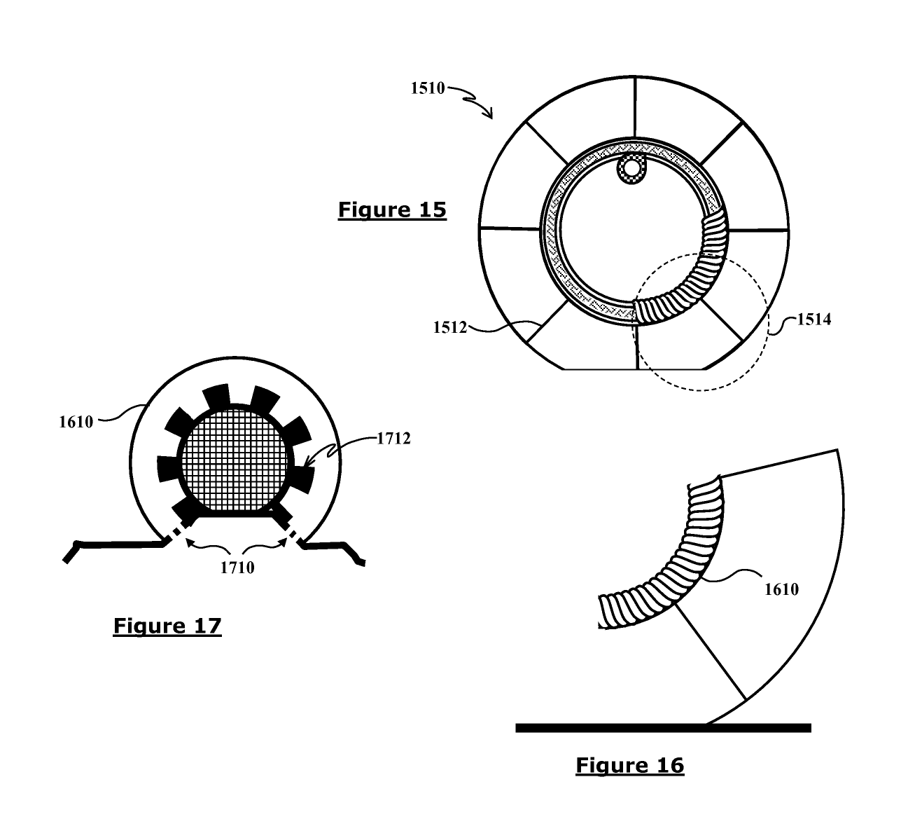

A partitioned tire aspect 1510 of the present invention is shown in FIGS. 15-17. A series of relatively rigid partitions 1512 radially spaced about the extent of the partitioned tire aspect 1510 divide the interior air space. The region within the dashed circle 1514 is depicted in expanded detail in FIG. 16, which shows a spiraling ducting 1610. The ducting 1619 provides the only air communication between adjacent divisions of the tire, and hence the movement of the contact patch about the tire drives airflow through the ducting 1610. FIG. 17 shows a cross-section view of a turn of the ducting 1610, with one way ports 1710 disposed in opposite air passing directions on opposite sides of the tire. The air flow through the ducting 1610 can then be used to drive a propeller 1712, and hence either directly or indirectly, a generator to harvest energy.

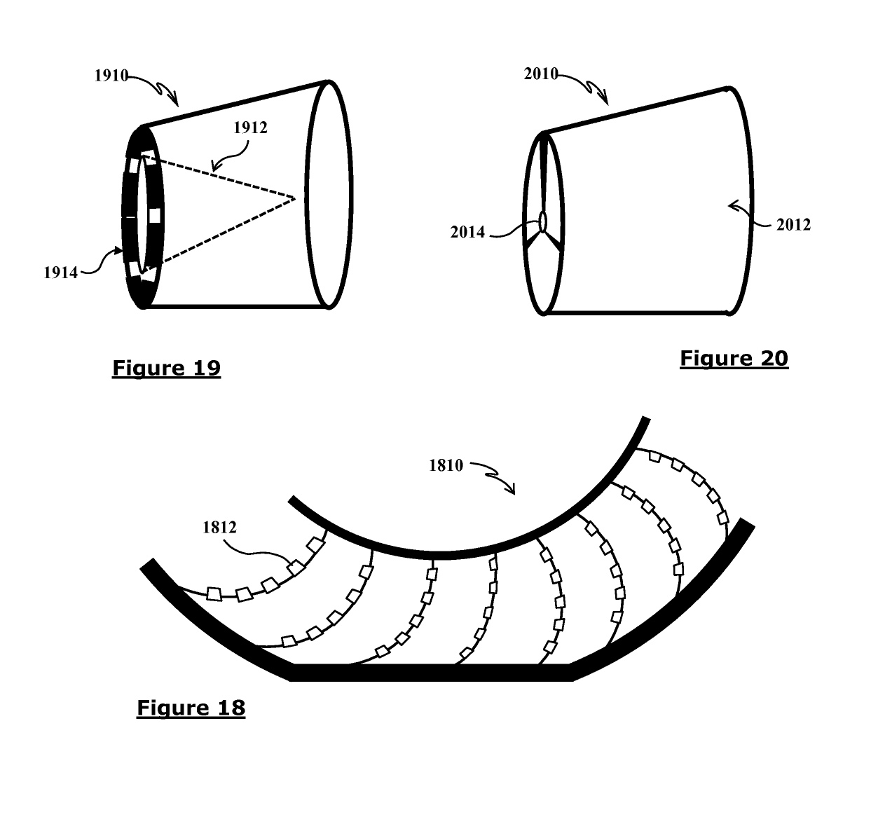

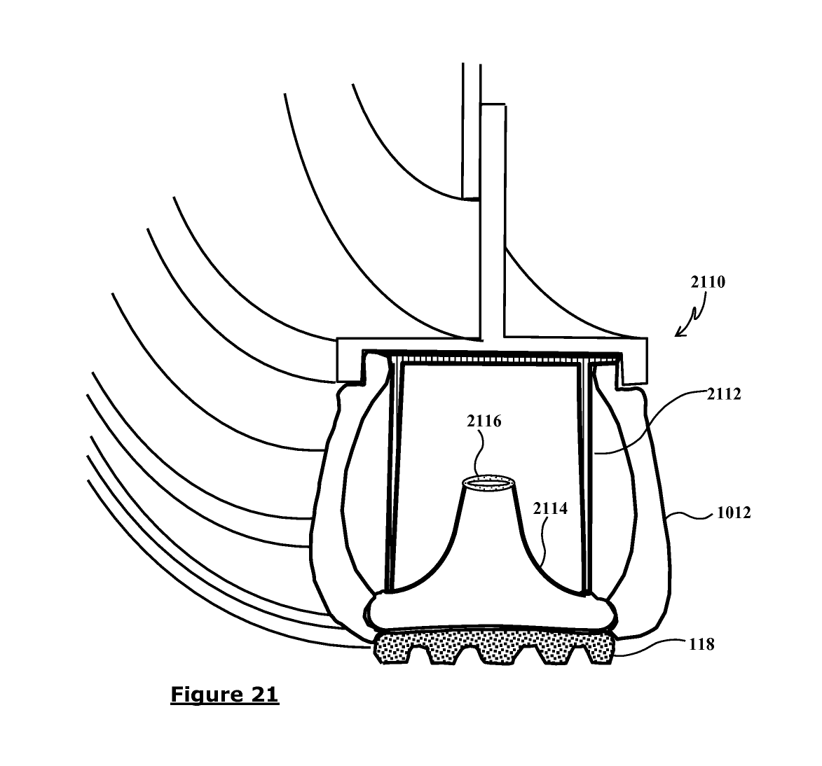

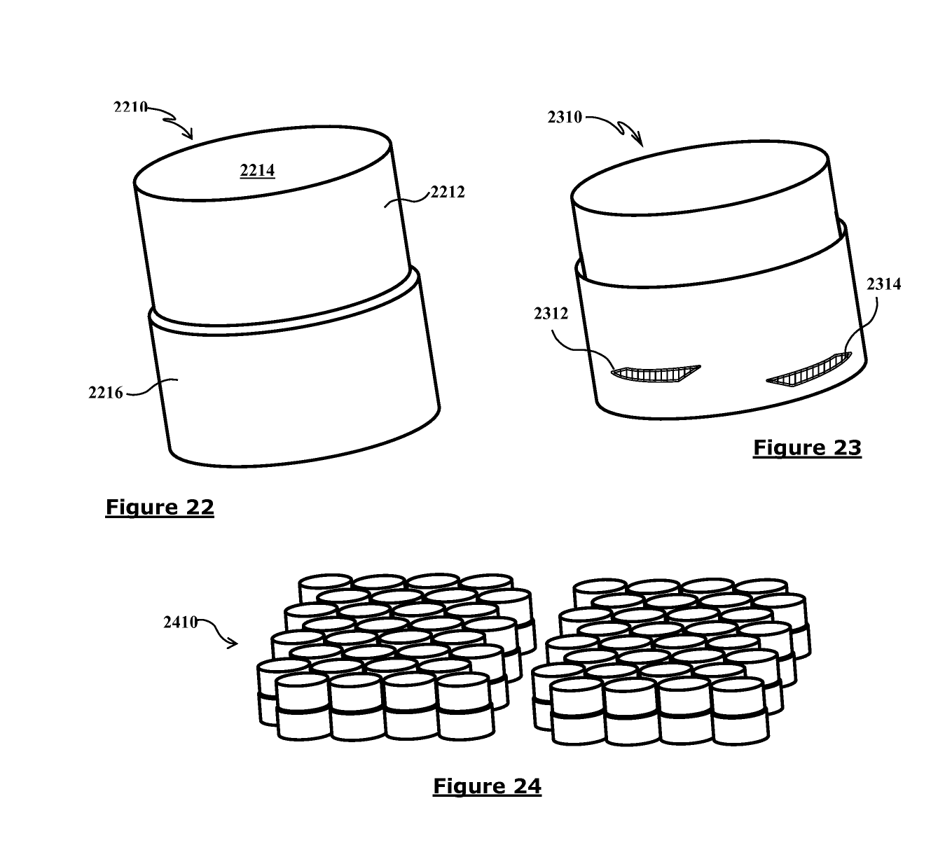

FIGS. 18-20 show a third membrane employing aspect 1810 of the present invention, wherein now the membranes 312 are also perforated, and disposed at the pores 1812 are arrays of energy harvesting mechanisms 1910 or 2010. Both of the mechanisms 2010 and 1910 employ a fairing 2012 which either channels airflow to a propeller 2014 to harvest energy, or after being shaped and thereby sped up by the venturi effect, by an internal cone 1912 the air flow can pass through a ring propeller 1914 to harvest energy.

A first tire and inner tube construction aspect 2110 is shown in FIG. 21. In the first tire and inner tube construction aspect 2110 the sidewalls 1012 also constrain an inflated volume for support, but the volume is subdivided. A support rail 2112 provides additional support to compensate for the potential reduction in support due to the subdivisions of the tire interior. The contact patch 118 is driven upward into the bladder 2114 thereby forcing air through the bladder neck 2116 where it can be utilized to drive generators and the like once again. The exterior of the bladder 2114 can be fitted with pressure responsive pores that close to outward movement of air when the pressure within the bladder 2114 is greater than the pressure in the tire interior, such as when over the contact patch 118, and open again when the pressure differential is reduced, such as when that portion of the tire is not over the contact patch 118.

A first auto-reverting aspect 2210 involves a first envelope 2212 which has the primary contact interface surface 2216. The sides of the first envelope 2212 can also be compressible, or accordion pleated (not shown,) to aid in its likelihood to compress easily and/or to aid in its expansion upon the cessation of the contact force on the surface 2214. Upon compression, the second envelope 2216 is relatively unchanged, while the first envelope 2212 is forced at least somewhat within the confines of the second envelope 2216 as shown in the configuration 2310 in FIG. 23. Frequently, the first auto-reverting aspect 2210 will be disposed in arrays 2410 across a surface as shown in FIG. 24, with adjacent (and with the aid of additional channels sometimes also more distant,) second envelopes having ports 2312 and 2314 enabling fluid intercommunication with their neighbor second envelopes 2216. Both the airflow within a given first auto-reverting aspect 2210 as well as airflow between neighbor first auto-reverting aspects 2210 can be used to harvest energy as described earlier. Often, one of the ports 2312 will only allow airflow in a single direction while the other port 2314 will only allow airflow in the opposite direction. By controlling these ports 2312 and 2314 to selectively open and close, or constrain or widen, as well as by selectively enabling, constraining, enhancing, or disabling the fluid communication between the first 2212 and second 2216 envelopes of a given first auto-reverting aspect 2210, The relative movement of the first 2212 and second 2214 envelopes can be selectively, and differentially controlled to achieve a multitude of benefits. For example, when arrayed across a tire surface, the first auto-reverting aspects 2210 about to enter the contact patch can be highly inflated to force the tire to overcome this rising of the boundary surface, and then allowed to deflate quickly, with the energy thereby expended being harvested to enable a new manner of regenerative braking. The differing first auto-reverting aspects 2210 in an array can also be selectively decommissioned in a pattern designed to enhance traction when so required, and the overall shapes and arrangements of any of the first auto-reverting aspect 2210 in an array can be widely varied (such as hexagonal patterns, and/or differing degrees of resistance to compression,) depending on the needs of a specific implementation.

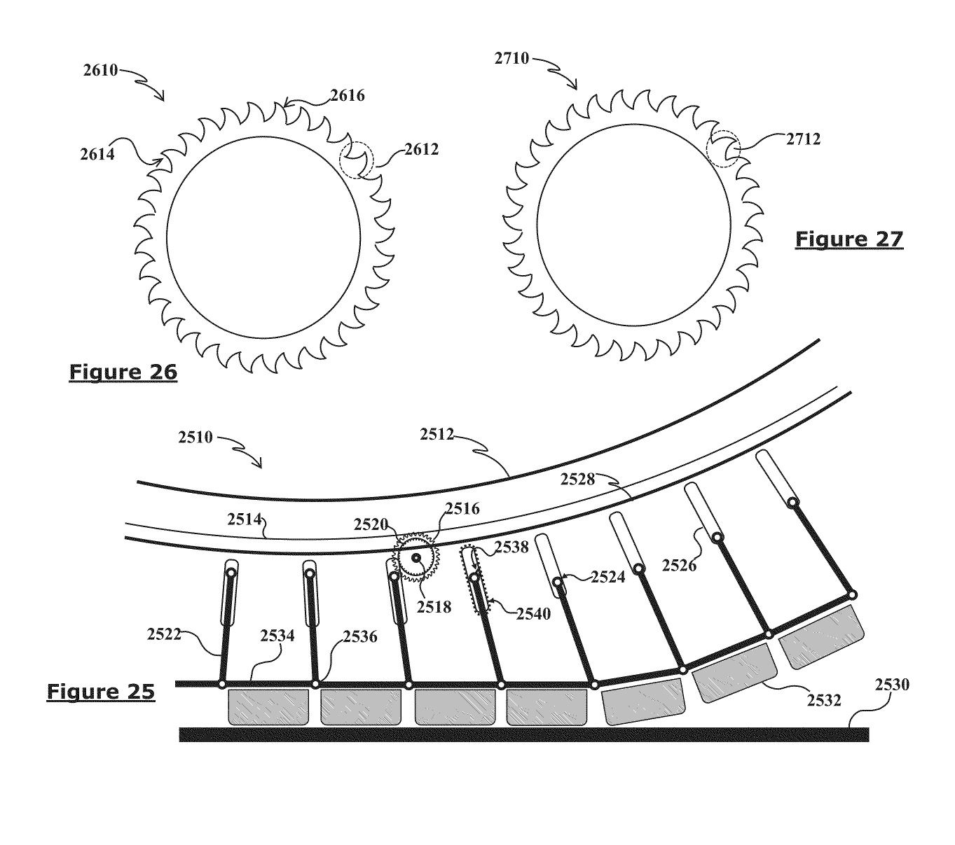

A representative portion of a first segmented-tread embodiment 2510 of the present invention shown in FIG. 25 has an internal wall 2512 between the internal air volume and the present embodiment mechanisms. A jointly utilized transducer 2514, such as a jointly driven raceway or a torqued flexing drive shaft, is disposed in contact with a uni-directional gear 2516 that is rotates about an axis 2518 which is held at a fixed distance from the internal wall 2512. A concentric gearing 2520 is driven by the upward movement of piston 2522 which drives a journal 2524 that rides in slot 2526, the slots 2526 being anchored to intermediate wall 2528 that is in turn anchored at a generally fixed distance form internal wall 2512. As the vehicle travels to the right across the substrate, such as road surface 2530, with the tire rotating clockwise, a plurality of tread segments 2532 are individually connected to individual tread backings 2534. The tread backings 2534 are interconnected by pivots 2536 that can be configured to enable varying degrees of relatively unfettered relative rotation between tread backings 2534. As the tread segment first begins to contact the road 2530, it is forced inward, towards the center of the tire as that segment takes on more and more of the load. Hence, pivots 2536, which are rotationally interconnected with pistons 2522, drive the pistons 2522 towards the center of the wheel which drives journals 2524 progressively inward through the length of slot 2526. The journal 2524 is also harnessed to a peripherally encompassing, at a connection 2538 to a recirculating gearing surface 2540 that in turn drives the rotation of the uni-directional gear 2516. Upon the translation of the tread flexing action when rotating as the vehicle travels, the embodiment 2510 translates its driving forces to transitioner 2514. It should be understood that the various elements described and shown separately in FIG. 25 and the present description are depicted in only partial deployments for the purposes of clarity of description, and that in operation, each of the tread slots 2526 also include a gearing surface 2540 and the uni-directional gear 2516. The assemblage of these unidirectional gears 2526 work in unison to jointly drive the transitioner 2514, which is in turn yoked to driving a dynamo/generator for conversion to electric power generation by any of a number of well-known approaches.

The uni-directional gears 2526 can be disposed in either of a pair of variants, depending on which way the drive is desired to be harnessed to the transitioner 2514. A clockwise driven gear variant 2610 is shown in FIG. 26, and an anti-clockwise gear variant 2710 is shown in FIG. 27. Individual gearing teeth 2612 and 2712 are disposed in reversed dispositions in the clockwise and anti-clockwise variants 2610 and 2710, respectively, which is the basis of their reversed directions of rotation. An engaging face 2614 has a concave surface that is cooperatively caught and driven by the gearing surface 2540, while an non-engaging face 2616 has a convex surface designed to slip by the gearing surface 2540 with a minimum of disturbance, so that when the load is taken off a given tread segment 2532, that tread segment 3532 and its attached piston 2522 can then return to its original, pre-loaded disposition without diminishing the efficiency of the operation of the transitioner 2514 as it recovers.

A representative portion of aspects of a second segmented-tread embodiment 2810 is shown in FIG. 28. The second segmented tread embodiment 2810 differs in a number of manners from the first segmented-tread embodiment 2510 that are illustrative of the range of varieties of construction that fall within the scope of the present invention. One primary difference is that the intermediate wall 2512 to tread space 2812 is substantially less than for the first segmented-tread embodiment 2510; while a second difference is that in the second segmented-tread embodiment 2810, the arm, journal, and slot combination 2814 has very little excess arm length extending outside of the slot when the combination 2814 is in its most compressed disposition 2816; and a third difference is that there is also very little excess above slot space 2818. These three differences all aid in employing the second segmented-tread embodiment in lower profile tire applications than are best with the first segmented-tread embodiment 2510. Additional benefits are also available and/or manipulable by varying the angle 2820 which defines the angle of inclination of the combination 2814, relative to the intermediate wall 2528, including gaining and/or selectively varying mechanical efficiency advantages by more efficiently aligning the drive stroke of the combination 2814 with the natural motion direction of the pivots 2536 when the pivots 2536 are being driven inwards towards the tire center by the changes in orientation and distance from the tire center undergone by the tread segments 2532 when coming into contact with the roadway 2530.

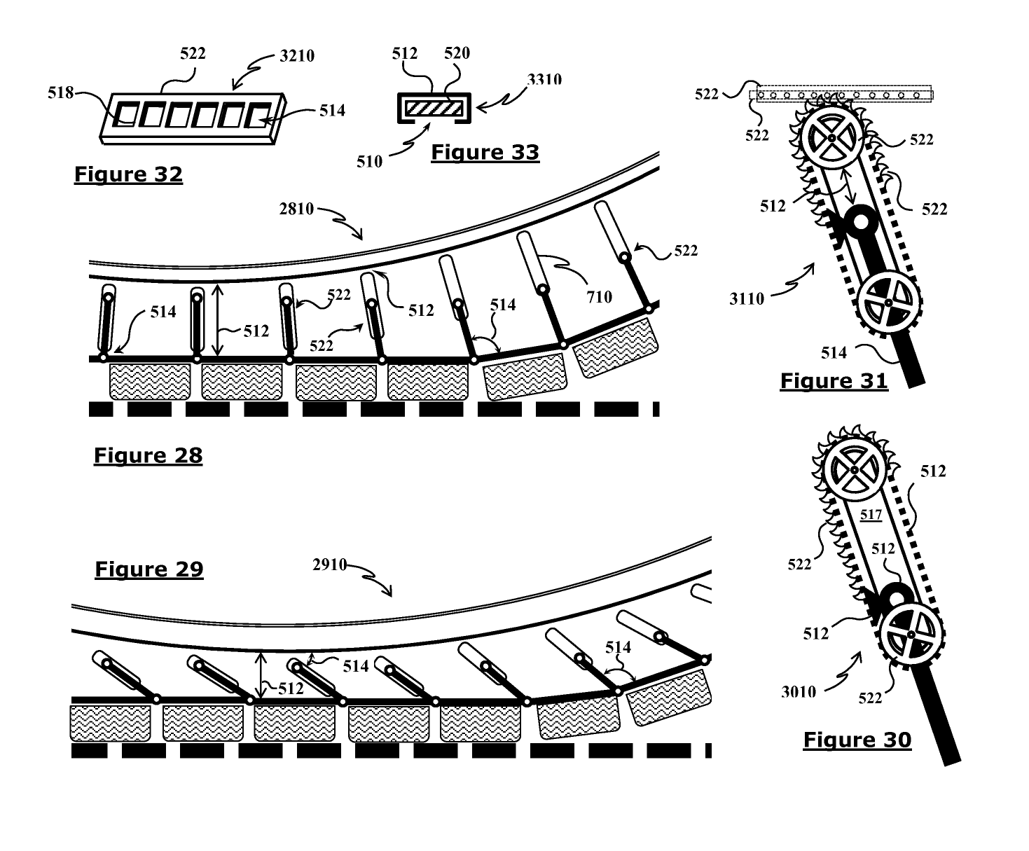

A representative portion of aspects of a third segmented-tread embodiment 2910 is shown in FIG. 29, which demonstrates another approach towards reducing the height profile 2912 of the space required to dispose the necessary mechanisms. Much of the third segmented-tread embodiment 2910 is similar in many respects to the second segmented-tread embodiment 2810 and the first segmented-tread embodiment 2510, and included among the differences are a substantially greater angle of inclination 2914 of the combination 2814. The relative lengths of the slots 2526 to the height profile 2912, and their relative anchor angle 2916 to the tire intermediate wall (since the slots 2526 are anchored in position relative to the framework of the tire structure by any of a variety of well-known means that are not shown for clarity of illustration of the inventive details,) are all selectively variable within certain ranges. These variations can also be used to institute variations in the positioning and orientation of the slots 2526 relative to the pivots 2536 for adaptability to differing desired profiles and levels of mechanical efficiency, which may need to be mutually compromised in certain deployments.

A representative expanded detail view of aspects of a uni-directionally endless bi-pulley gearing transitioner 3010 is shown in FIG. 30 in a power pre-stroke disposition, and in FIG. 31 the transitioner 3010 is shown in a power mid-stroke disposition along with its relation 3110 to a raceway 3112 and a channel 3114 that the raceway 3112 travels within. The gearing belt 3012 (constructed of any suitable material and in any suitable manner of construction,) is driven by the journal 2524 connection via a bridge 3014, so that when the journal 2524 is driven up the slot 2526 the belt 3012 is rotated about the bi-pulleys 3016 in a clockwise direction. The clockwise movement of the belt 3012 drives the uni-directional teeth 3018 clockwise as well thereby engaging with and driving the raceway 3112 to the right (as shown) through the channel 3114.

An expanded detail perspective view of a raceway portion 3210 is shown in FIG. 32. The raceway 3210 includes side rails that are spanned by a plurality of cross-bars 3214 that are engaged by the uni-directional teeth 3018 when they are driven in the clockwise direction of FIGS. 30 & 31. On the return stroke, which is usually driven by the tire's internal pressure via strategically routed air channels (not shown,) the unidirectional teeth 3018 demonstrate their benefit by not significantly engaging the raceway 3112 when driven in the counterclockwise direction on the return stroke and hence minimizing the obstruction of the energy harvesting efficiency by the teeth 3018 during the return stroke.) The teeth 3018, during the power stroke, engage the raceway 3112 by engaging with the cross-bars 3214. FIG. 33 shows a longitudinal cross-section view (with the raceway moving perpendicular to the plane of FIG. 33) of the relationship 3310 of the raceway 3112 and the channel 3114.

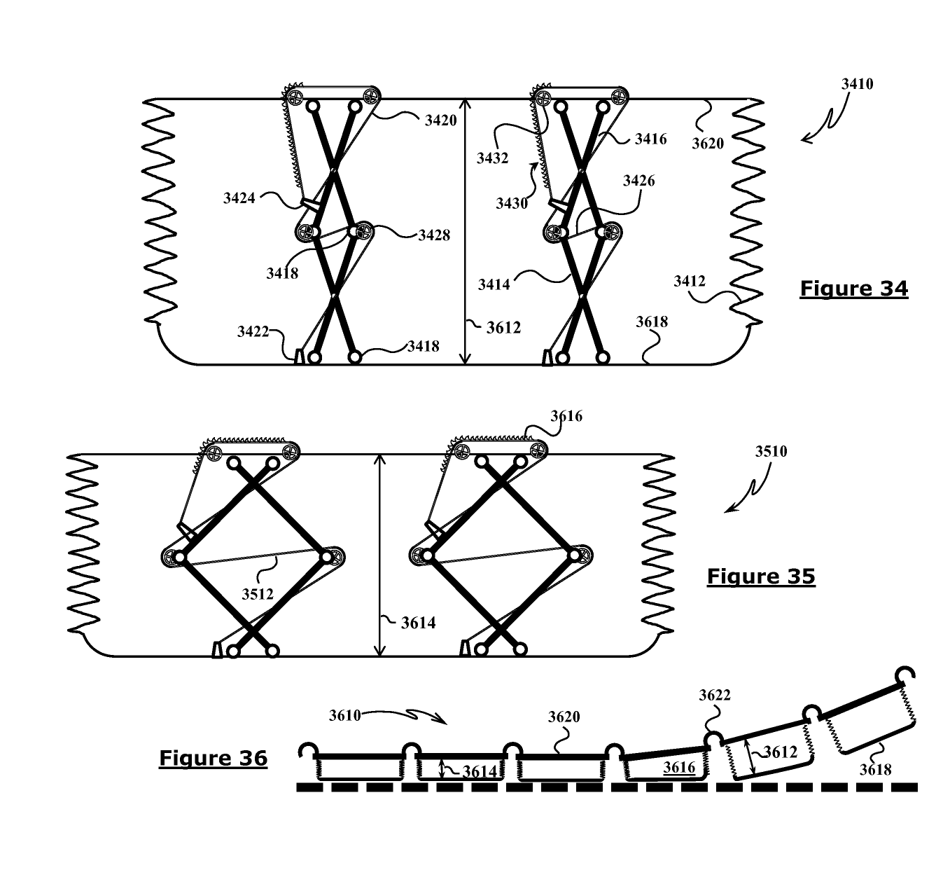

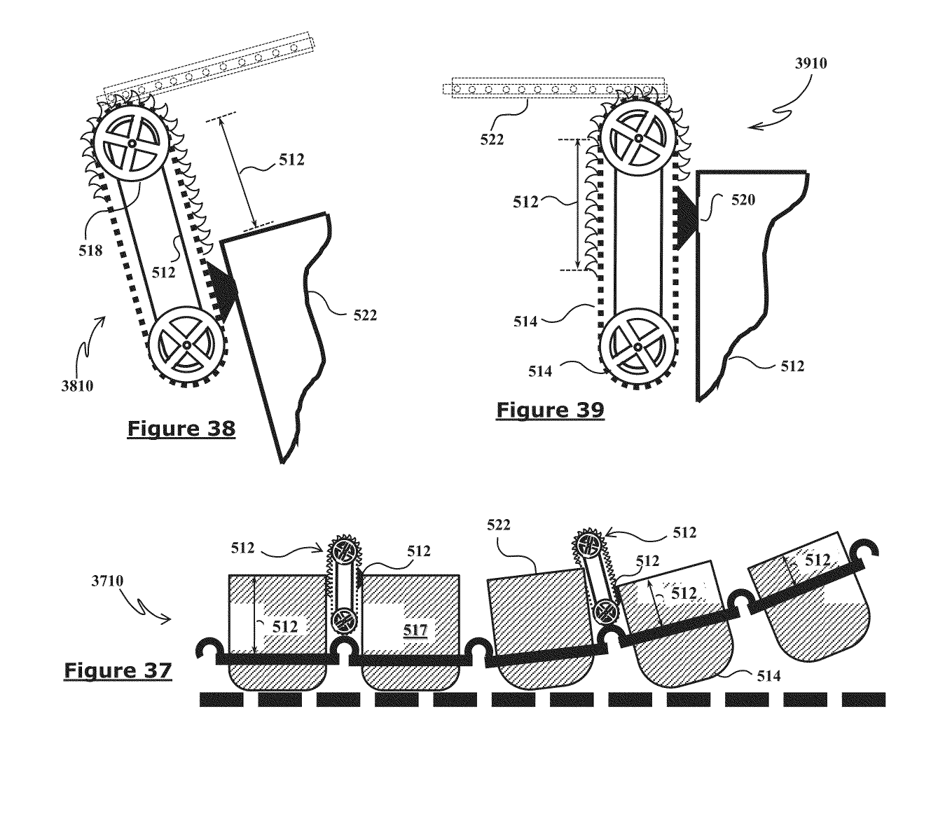

A scissor-arm modular embodiment 3410 is shown in an extended disposition in FIG. 34 and in a compressed disposition 3510 in FIG. 35. The scissor-arm modular embodiment 3410 is enclosed within a flexing envelope 3412 that is depicted as having accordioning sides, though any other form of flexing construction also falls within the scope of the present invention. A representative portion of aspects of a first flexing linkage segmented-tread arrangement 3610 shown in FIG. 36 is well suited for incorporation of the scissor-arm modular embodiment 3410, as well as many other modular embodiments of the present invention. When the internal uncompressed height 3612 of an individual module of the scissor-arm modular embodiment 3410 is reduced to the compressed height 3614, the internal space 3616 within that module is reduced significantly. The reduction in height occurs, of course, when the tread modules encounter tread surface 3618 as they are rotated into load bearing dispositions 3510. As shown in FIGS. 34, 35, & 36, the exterior tread surface 3618 is relatively stiff, while the flexing envelope sides 3412 are relatively pliant (though both of these characteristics can be varied) so that the module, when compressing, can have one side of the module being compressed more than the other, which also leads to benefits of having paired internal transitioners. The independently flexing sides and independently acting internal cable and scissoring arms transitioners 3414 enable the modules to more readily conform to the roadway and thereby potentially achieving smoother and more effective performance. The modules have a relatively stiff module upper wall 3620 to provide the structural foundation for the various forces to react off of either directly or indirectly. The module upper walls 3620 are connected by pliable couplings 3622, and thereby form another variant of a segmented tread that is also suitable for employment with a number of other aspects of differing embodiments of the present invention.

The cable and scissor-arm transitioners 3414 are comprised of upper and lower scissoring interconnected arms 3416 that are interconnected at pivot joints 3418, and are connected to the closest, respectively, upper or lower module wall by similar pivot joints 3418. A cable 3420 is wrapped through and around the upper and lower scissoring interconnected arms 3416, around various pulleys, and is fixed at lower wall anchors 3422 and arm anchors 3424. When the height of the module is decreased from its uncompressed height 3612 to its compressed height 3614, the scissoring arms 3414 move from the disposition depicted in FIG. 34 to the disposition depicted in FIG. 35. The cable portion 3426 that runs between the upper and lower scissoring arms 3416 middle pulleys 3428 is thereby extended to an increased length 3512. A length of uni-directional gearing teeth 3430 is disposed on a section of the cable 3420, in position to be pulled around pulley 3432 so that they are pulled into a linear run just outside of and parallel with the module upper wall 3620 in a disposition suitable for driving a raceway 3112, for example. The expansion of the length 3512 drives the length of uni-directional gearing teeth 3430 into the disposition 3616. Of course, it should be understood that the selected illustrative details of the particular scissoring embodiment depicted are chosen more for clarity of illustration than for practicality of implementation, when the two conflict. Hence, is should be understood that the present embodiment encompasses a wide range of scissoring type mechanisms, and is not limited to the present example's details.

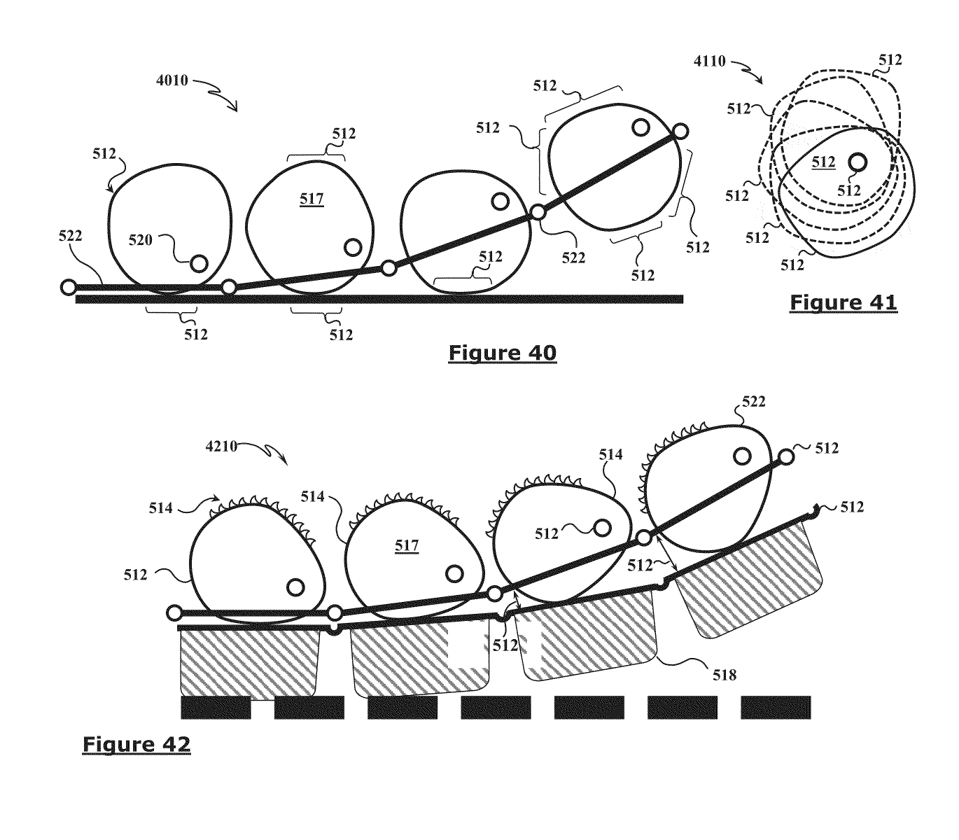

A representative portion of aspects of a first shuttling tread embodiment 3710 depicted in FIG. 38 include a plurality of shuttling tread elements 3712 that translate linearly relative to the tread frames 3714 which allow a selected amount of linear translation by the shuttling tread segment 3710. As the shuttling tread segment 3712 moves inward form height 3716 to height 3718 to final height 3720 it drives the uni-directionally endless bi-pulley gearing transitioner 3010 which is driven by the movement of the shuttling tread segment 3712 via the bridge 3722. The uni-directionally endless bi-pulley gearing transitioner 3010 is fixed in position, relative to the tread frames 3714, so that the upward movement of the shuttling tread segment 3712 drives the uni-directional teeth 3018. As shown in expanded detail in FIGS. 38 and 39, the uni-directionally endless bi-pulley gearing transitioner 3010 and its bridge interconnection to the upper corner of the shuttling tread segment 3712 are disposed in and pre- and post-work phase dispositions, respectively.

A representative portion of aspects of a first eccentrically reciprocating tread segment embodiment 4010 is shown in cross-section in FIG. 40. The eccentrically reciprocating tread segment embodiment 4010 is comprised of (in this case though not limited by this framework in general) a framework of frame backings 2534 interconnected with pivots 2536. A series of first eccentric cams 4012 each have a rotational axis 4014 that is held (structure not shown for purposes of clarity of illustration) in a fixed disposition relative to each cam's underlying tread backing 2534. Each of the first eccentric cams 4012 are able to rotate to a selected degree about its axis 4014. Often the rotation will be limited, for example, by a rotational constraint (not shown) that will stop the first eccentric cam 4012 from rotating clockwise as far as in disposition 4016, wherein the tread backings 2534 and/or the pivots 2536 come into contact with the underlying substrate, and will instead stop the first eccentric cam 4012 in the disposition 4018 wherein only the first eccentric cam 4012 comes into contact 4020 with the substrate. This embodiment is particularly well suited for adaptation to rolling support situations other than vehicles traveling across a roadway, such as many industrial factories and production sites (like mines) that utilize rolling supports in controlled circumstances like, for example, mass production lines. Many different forms of cam shapes and compositions can have utility in different circumstances. For example, a flatter cam upper boundary portion 4022 can provide differing effects when forced to rotate clockwise by the first eccentric cam 4012 encountering the substrate than a more rounded cam upper boundary portion 4024, and vice versa. Similarly, differing effects can be produced by differing geometries of a first cam lower boundary portion 4026 and a second cam lower boundary portion 4028. Additional benefits are also achievable by shaping a cam's initial contact boundary portion 4030 that first encounters the substrate and may be desired to, for example, minimize noise or vibration.

A plurality of first eccentric cam 4012 alternative dispositions 4110 are shown in superimposition in FIG. 41. As can be seen, variations in the forms of the particular portion of the first eccentric cam 4012 that is in contact with the substrate, as well as the portion of the cam boundary that is in contact with any overlying elements, such as a transitioner and/or transducer, can provide differing capacities to provide differing benefits. Additionally, varying the coordination of the cam portion having a particular form selected to be exposed on the upper cam boundary with the selection of the cam portion having the particular form to be exposed on the lower cam boundary provides an additional manner of providing further benefits, wherein for a particular implementation it may be beneficial for one boundary portion to be flatter to maximize thrust transfer from the substrate, while in another implementation it may be preferential to select an upper boundary portion form to be more curved for better engagement with a raceway, for example.

Another embodiment that utilizes eccentrically rotating cams is also the first embodiment to utilize a bi-layer segmented tread. It is within the scope of the present invention to utilize any number of active layers in the various embodiments, and it is correct to characterize at least some of the previously described embodiments as multi-layered, but the label of bi-layer is being used at this time to denote the principle of utilizing the relative dispositions of the two cooperating layers in the bi-layered embodiments to effect a significant portion of the energy harvesting process. A eccentrically reciprocating cam bi-layer segmented-tread embodiment 4210 is depicted in side cross-section view in FIG. 42. A lower layer is composed of a pliant segmented tread, for example, and the upper layer, in this example, is a pivoting segmented tread (it is within the scope of the present invention, of course, that either of the upper or lower tread can be constructed of the other listed type, as well as many others.) As the tread segments encounter the roadway, the distance between the layers is reduced from an unloaded height 4212 to a reduced height 4214 during loading. This drives the eccentric cams 4012 to rotate about their axes 4014 thereby driving the uni-directional teeth clockwise for engagement, for example, with a raceway 3112.

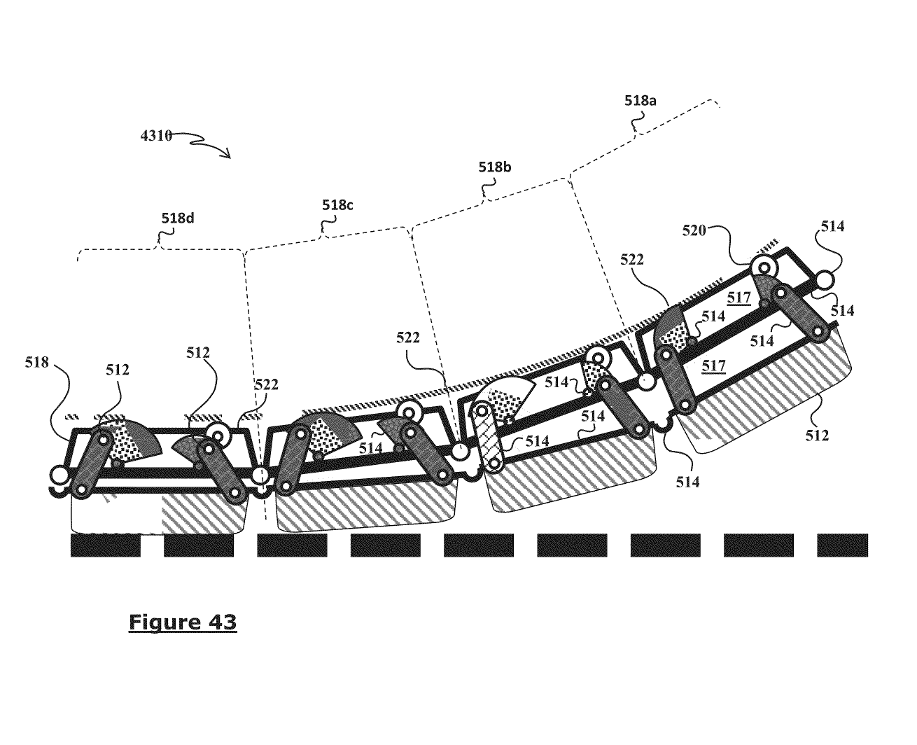

A dual arm & cam bi-layer embodiment 4310 is depicted in side cross-section view in FIG. 43. In this embodiment the upper pivoting segmented tread layer supports device chambers 4312 disposed on the upper side of the upper segmented-tread upper layer. The device chambers 4312 provide situating venues for first and second layer connecting arms 4314 & 4316, respectively. The first arm 4314 is pivotally connected below to the lower layer tread backing 2534, and is also pivotally connected to a cam 4316 that engages with a transitioner 4318 (transitioner 4318 can be the raceway 3112, or a rotating driveshaft (not shown)). The second arm 4316 is pivotally connected the lower layer tread backing 2534 and is pivotally connected above to a mini-cam 4320 that in turn rotates a mediating gearing 4322 (to align the direction of thrust with the direction produced by the cam 4316) which also engages the transitioner 4318. As the bi-layers are thrust together in the evolution from disposition 4324a through to disposition 4324d, the first and then the second arms 4314 and 4316, respectively, are forced upward, relative to the upper layer, and hence force the rotation of the cams.

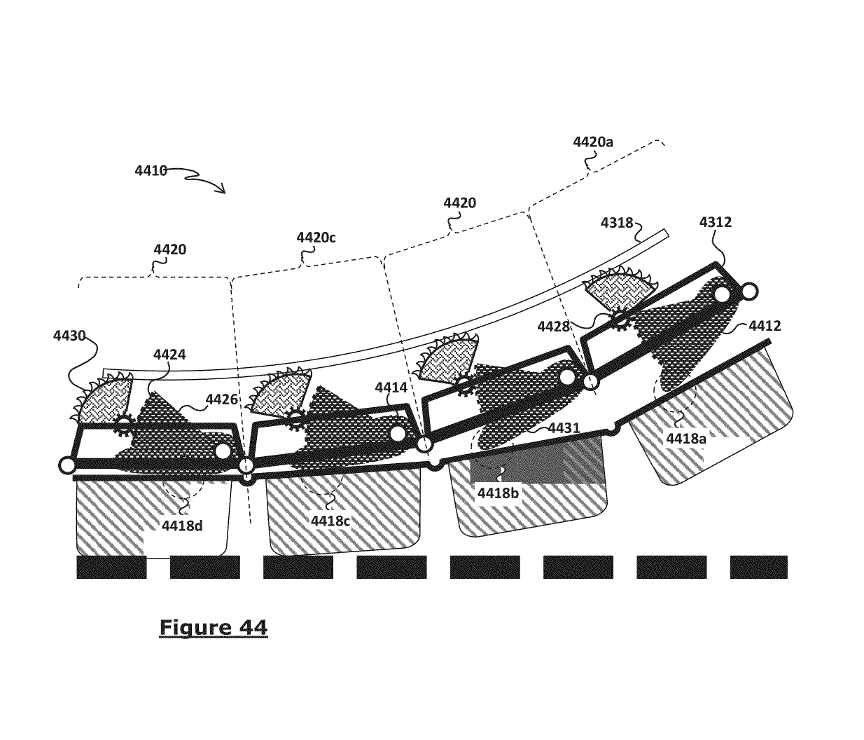

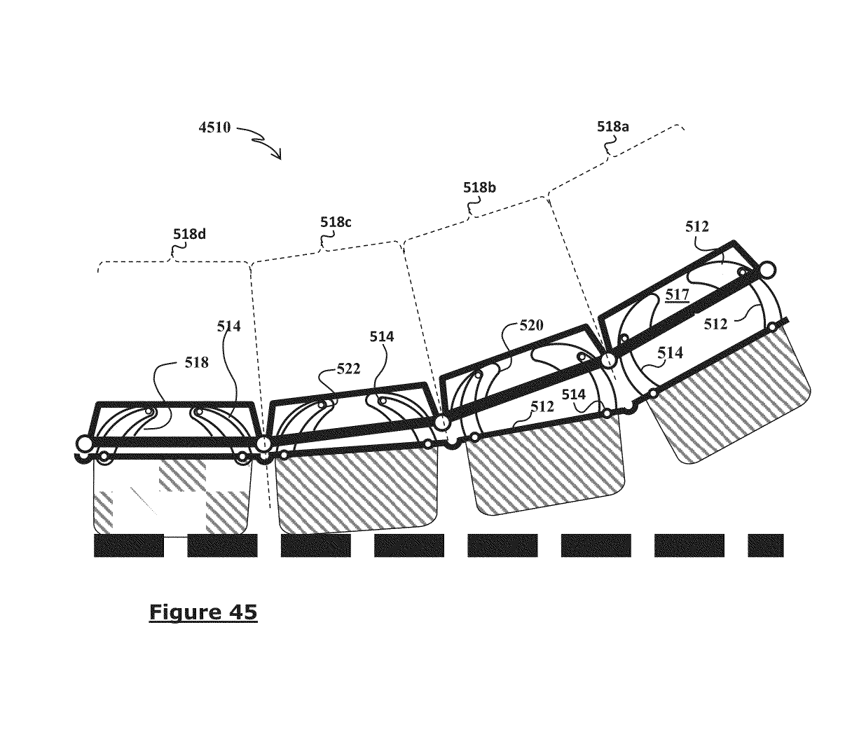

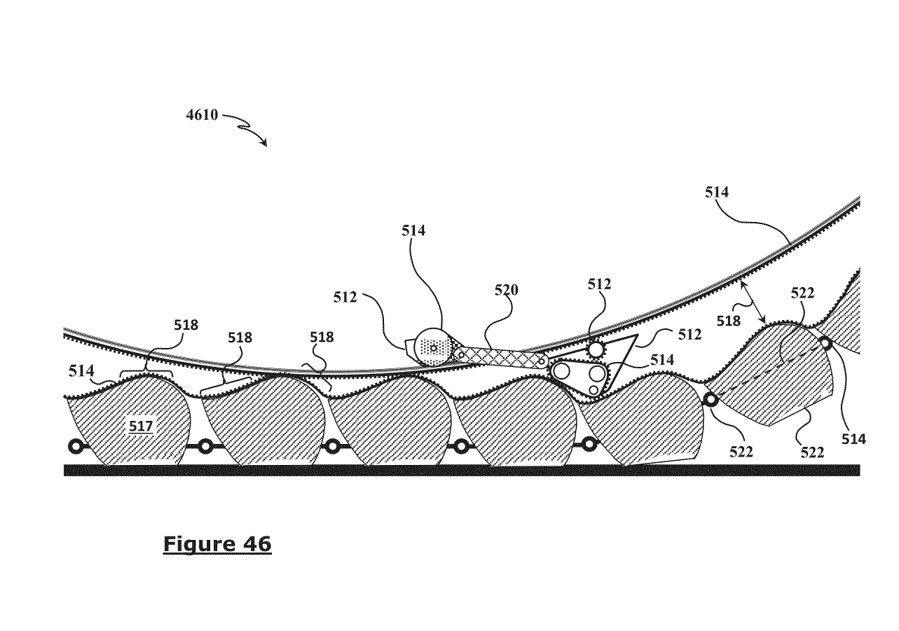

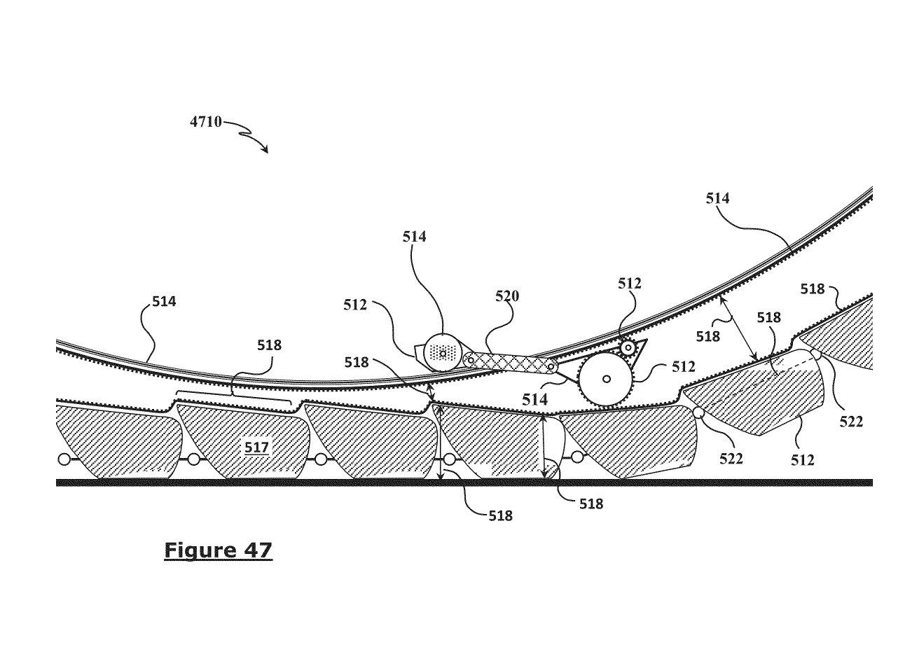

A dual cam amplifying bi-layer segmented-tread embodiment 4410 is depicted in side cross-section view in FIG. 44. A translating cam 4412 is rotationally anchored to the upper device chamber 4312 at its pivot axis 4414, and includes a forcing lever 4416 that contacts with the upper side of the lower segmented-tread layer in a progression of dispositions ranging from 4418a through to 4418d as the tread segments transition from phase 4420a through to phase 4420d. Other arrangements for the forcing lever 4416 are envisioned and fall within the scope of the present invention, and in the case illustrated in FIG. 44, the lever is lengthened in the direction of first contact 4418a to provide a faster pickup when the force begins to be applied, and is much broader in the area of contact cavity which will be bearing the majority of load bearing needs. A geared engaging surface 4424 is disposed along a force transfer arc 4426 of the translating cam 4412, and the surface 4424 engages with an inner cog 4428 that is concentric with a uni-directionally toothed (optionally) outer cam 4430. This embodiment's amplifying occurs because the concentric increase in radius from the inner cog 4428 to the outer cam 4439 greatly speeds the resultant movement of the cam teeth.

A dual limb and cavity bi-layer segmented-tread embodiment 4510 is depicted in a side cross-section view in FIG. 45. The dual limb and cavity bi-layer segmented-tread embodiment 4510 is similar in framework construction to the dual cam amplifying bi-layer segmented-tread embodiment 4410. First and second limbs 4512 and 4514, respectively, are both individually pivotally connected to the lower layer 2534 and are journaled 4516 at their upper end to ride in cavities 4518 and 4520, respectively, that are formed within the device chamber interior 4522. The transitioners (not shown) and/or transducers (not shown) that convert the forces harnessed by the present embodiment can be driven by an interconnection to the journal 4516 or by the interaction of the limb surfaces with the cavity surfaces, as the tread segments transition from phase 4522a through to 4522d thereby driving the limbs up the cavities.

A cross-section side view of a representative portion of a first non-linear shuttling tread segment embodiment 4610 that includes a first traveling transducer aspect 4612. Asymmetrical tread segments 4614 are able to shuttle up and down relative to the uni-layer pivoting segmented-tread framework, with limited degrees of angular freedom of orientation, subject to constraints imposed by the freedom of movement allowed by the segmented-tread framework, and the forces that the various tread segments are subject to. The internal air pressure in the tire normally presses the tread segments 4614 outward as far as they are free to move, except for when the weight of the vehicle presses them into the roadway. The leading (so-named since it contacts the roadway first) portion of the tread segment 4614 has a height that is substantially higher than the trailing tread segment portion height 4616. The effects of (a) these tread segment height variations; (b) the available movement allowed by the tread segment framework; (c) the dispositions effected by the tread segments 4614 when undergoing the movements forced by the roadway; (d) the differences in the unloaded intermediate height 4610 vs. the loaded intermediate height 4622; and the physical dimensions and operations of the first traveling transducer aspect 4612 all combine to produce a power squeeze upon the first traveling transducer aspect 4612. The counterclockwise progressing narrowing of the intermediate space 4622 forces the first traveling transducer aspect 4712 counterclockwise as well, with a primary driving force being supplied by the geared lining 4624 that smooths the application of force, in concert with a flattened upper (facing inward) face 4625, to the first traveling transducer aspect 4712. A geared wheel 4626 engages with an outer geared lining 4624 and translates the driving force to a pulling cog 4628 that engages with an inner geared lining 4630 to propel the first traveling transducer aspect 4712 counterclockwise. A tow-bar 4630 portion of the first traveling transducer aspect 4712 yokes a generator stator 4632 and rotor 4634, the rotor being turned by the combination of the tow-bar 4630 pulling and a drag surface 4636 which does not allow the rotor to slide, hence forcing it to rotate and generate electricity.

A cross-section side view of a representative portion of a second non-linear shuttling tread segment embodiment 4710 that includes a second traveling transducer aspect 4712. The second non-linear shuttling tread segment embodiment 4710 is similar to the first non-linear shuttling tread segment embodiment 4610 and primarily differs in the profiles of the tread segments 4712 and their allowed ranges and forms of motion, as well as features of the second traveling transducer aspect 4714. The tread segments 4712 have a complexly curved upper (facing inward) face 4716 which can be widely varied, and the particular aspects of the upper face 4716 shown is merely illustrative and are not limiting. The action of the upper face 4716 is translated to a geared endless cable assembly 4718 feature of the second traveling transducer aspect 4714. In the case of the upper face 4716, an initial face portion 4720 is shaped for efficient force translation when the tread segment 4712 is forced upward at its left end (as shown) by the initial contact with the roadway, while the right end is generally still stationery, so that he tread segment is rotating clockwise. A middle face portion 4722 is shaped for efficiency when the tread segment right end is moving upward as the left end is also moving upward, and hence the tread segment is traveling with less net rotation, though after a degree of clockwise reorientation has occurred. An ending face portion 4724 is shaped for efficiency when the tread segment left end has generally traveled through the majority of its motion, and the tread segment right end is still traveling upward, so that the tread segment is then rotating counterclockwise. The differences in contour of the tread segment upper face 4716 lead to a substitution of the cable assembly 4718 for the geared wheel 4626. The cable assembly 4718, by routing the gearing around three pulleys, is able to present a longer engagement surface that is more adaptable to engagement with differing tread segment face portion geometries.

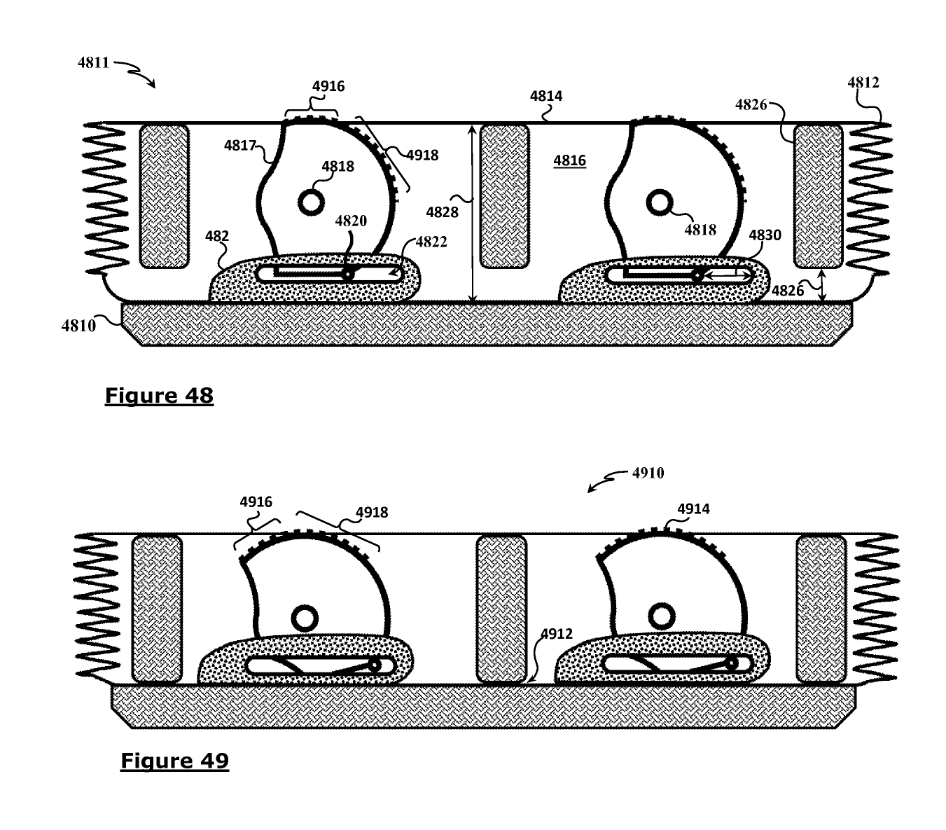

A representative portion of aspects of a single geared, dual cam modular embodiment 4810 is shown in an extended disposition 4811 in FIG. 48 and in a compressed disposition 4910 in FIG. 49. The single geared, dual cam modular embodiment 4810 is contained within a flexible sided device envelope 4812 that has a relatively stiff upper surface 4814, and is disposed upon a tread segment below. Within the interior 4816, a pair of cams 4817 are disposed to rotate about their respective axis 4818 (that are held by any well-known, but un-shown, structure in a fixed position relative to the upper surface 4814, and are driven both clockwise and counterclockwise by their respective rotational couplings 4820 being journaled within slots 4822 that are formed within supports 4824. As the bottom of the envelope 4812 is driven upward by contact with the roadway, its upward motion is available for a height 4826 until the bottom encounters 4812 structural supports 4826 (which also can be disposed as attached to the bottom, or a side, or other variations.) The height of the supports and the overall height 4828 of the envelope when uncompressed as in FIG. 48 can be varied to produce differing degrees of rotation of the cams 4817. The compression of the envelope drives the couplings 4820 down the length 4830 which turns the cam 4817 counterclockwise so that a gear 4914 rotates from its initial portion 4916 being available for engagement with a transitioner or transducer, to its trailing portion 4918 being in engagement. Though shown in a cross-section that could be either transverse or longitudinal, both of which fall within the scope of the present invention, the relative direction of the arc rotation including diagonals, the relative dimensions of the various components themselves, as well as the location and number to dispose within a tread segment, including at the four corners, are all variable to enable this embodiment to adapt to differing circumstances. This adaptability also highlights the wide nature of applicability of this embodiment, such as in a multi-segmented walkway at a conference center as cushioning rather than a carpet, or cushioning on a roadway, though care should be taken to avoid leeching energy, rather than only harvesting from waste.

A representative portion of aspects of a third non-linear shuttling tread segment embodiment 5010 having a fluid and bearings mediated transitioner aspect 5012 in a side cross-section view in FIG. 50. Tread segments 5014 are shaped somewhat differently than the previous embodiments, but operate similarly and illustrate through their differing ranges of motion some of the broad range of varieties that are available with the embodiments of the present invention. In this embodiment, the squeezing effect of the upward movement of the tread segments 5014 presses on a fluid envelope holding a machine oil, for example, that moderates, regulates, and translates the force to a sleeve 5016 lower surface that contains a plurality of bearings 5018 which are constrained to remain in single file, though freely able to roll with little friction in the fluid 5020. As the available height 5022 for the sleeve 5016 and bearings 5018 is squeezed down, the closing lead edge 5024 of the sleeve 5016 upper surface pushes the bearings 5018 in a counterclockwise direction which thereby turn the transitioner gears 5026 which drive the generic transitioner 5028 that can be the raceway 3112, for example.

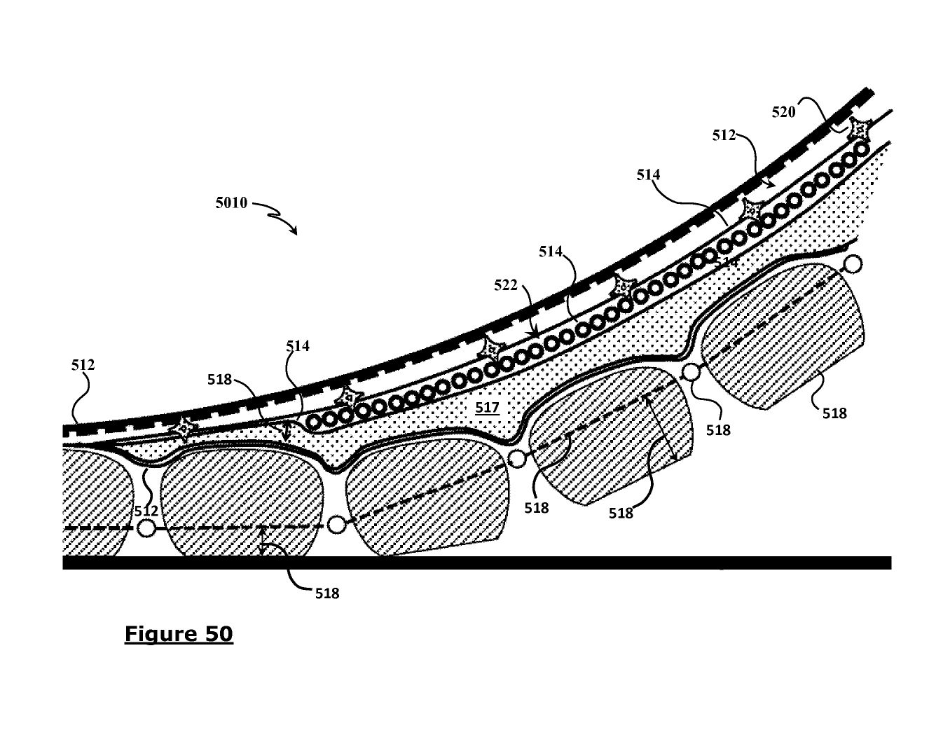

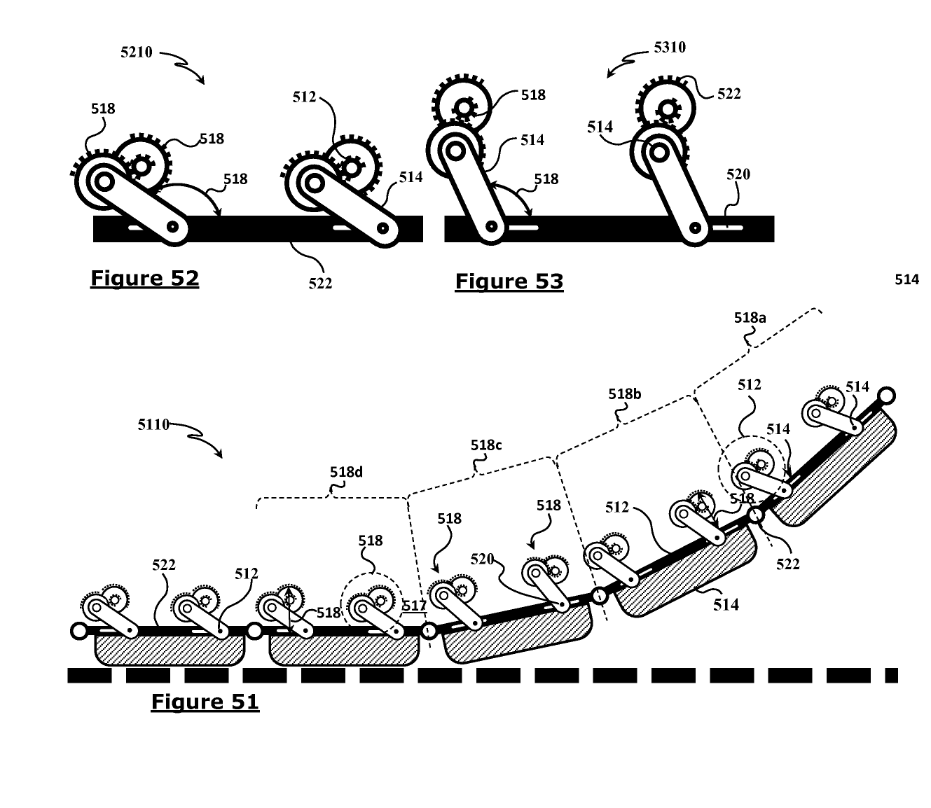

A representative portion of a first pendulum arm embodiment 5110 is depicted in a cross-section side view in FIG. 51. A unilayer of tread segments are pivotally connected and have pairs of horizontal slots 5114 formed within them. A pivoting coupling 5116 that is journaled to slide in one of the slots 5114 constrains the motion of the lower ends of first pendulum arms 5118, which are disposed in front and back pairs to interconnect the unilayer segmented-tread 5112 with the tire intermediate structure (not shown). At their upper ends, the first pendulum arms 5118 pivot about axis 5120 which is held in a fixed position relative to the tire interior structure. FIGS. 52 and 53 illustrate more clearly in expanded detail views the actions of the pendulum gearings, in a closely related variant of the present embodiment (the primary difference being that the gearings have a somewhat greater degree of motion available in FIGS. 52 and 53, due to a limited degree of relative motion of the axis 5120 relative to axis 5121. In FIG. 51, the pendulum arm 5118 upper end is attached to a gear 5122 that engages with a smaller gearing 5124 that is attached to a concentric larger gearing 5126 that engages with a transitioner (not shown) such as a raceway 3112. As the tread segments are force inward by contact with the roadway, the pendulum arms 5118 applicant's representative forced in to a clockwise pivoting action ending at an angle 5212, from an initial angle of 5312, thereby driving the amplified clockwise rotation of the concentric larger gearing 5126.

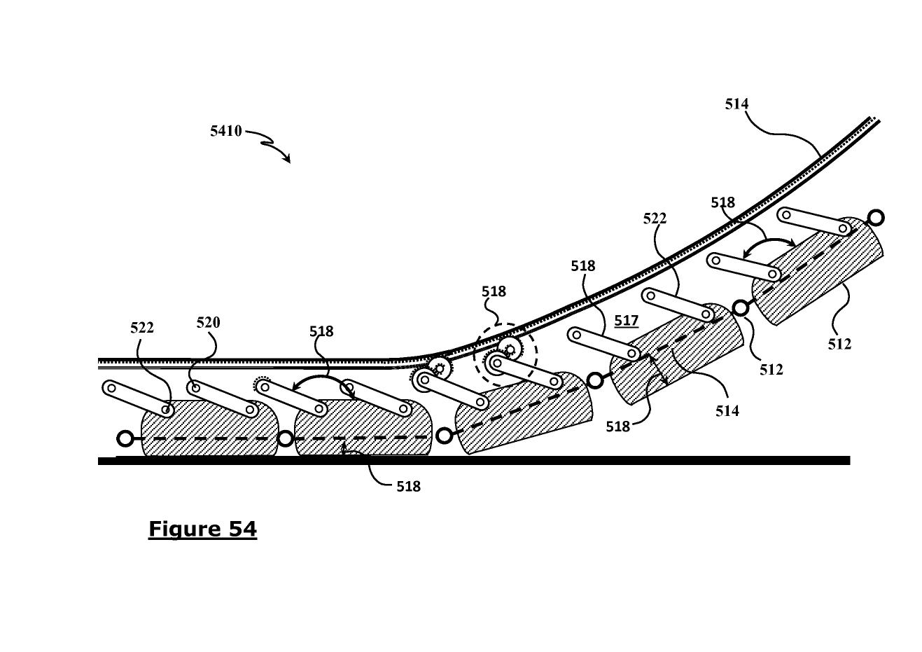

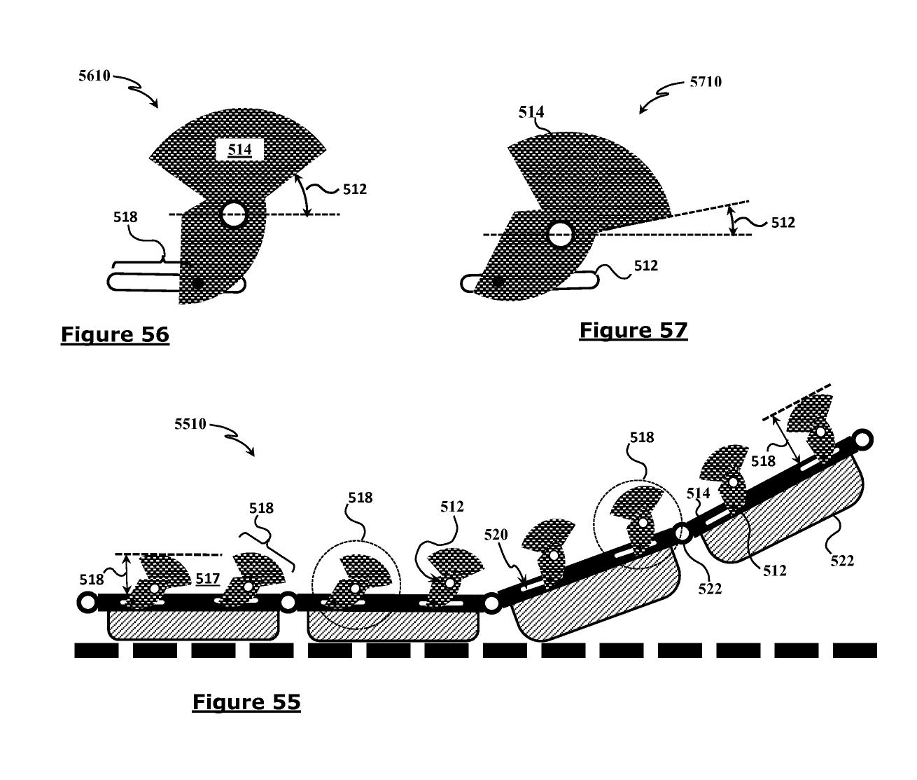

A representative portion of a second pendulum arm embodiment 5410 is depicted in a side cross-section view in FIG. 54. The second pendulum arm embodiment 5410 is very similar to the first pendulum arm embodiment 5110, differing primarily in the absence of slots 5114 and longer and more steeply angled pendulum arms 5412, as well as a limited freedom of motion of the tread segments relative to the segmented-tread framework. These provide additional degrees of freedom of motion, though at the potential cost of lesser mechanical efficiency. The angle between the pendulum arms and the tread segments (roughly equal to the angle change of the pendulum arms 5412) execute a change from 5416 to 5418 which is then translated into thrust applied to a transitioner, such as raceway 3112, that transitions the power for eventual conversion to electricity.

A side cross-section view of a representative portion of a second pendulum arm embodiment 5510 of the present invention is depicted in FIG. 55. The tread segments 5512 are connected to dual action pendulums 5514 that rotate about axis 5516, while the axes 5516 are anchored in the next more inward suspending layer (not shown) of the tire structure. The suspending layer and the tread segments are constrained so that the axes 5516 each move approximately perpendicularly towards (and away from) the tread segment 5512 to which it is connected, thus the pendulums 5514 are rotated clockwise when the tread segments 5512 are moved upward towards the suspending layer as they encounter the roadway and assume the load of the vehicle. The rotation of the pendulums 5514 is controlled by a sliding pin 5518 that travels in slot 5520 as the suspending layer and the tread segments layer become closer, until they are practically adjacent, as shown in disposition 5710 in FIG. 57, wherein the axis 5516 is in close proximity to the tread segment framework 5522. The second action of the pendulums 5514 is due to their reverse side cam face 5524 that engages with a transitioner (not shown) to transition the thrust generated when the pendulums are rotated clockwise (by the closing together of the suspending layer and the tread segments) for (eventual) electricity generation. The radius of the cam face 5524, from the axis 5516, can be varied, as can its length of arc, for varying effects, such as reducing the radius so that the post rotation disposition 5710 can fit into a reduced loaded tire profile height 5526. The total rotation angle executed by the pendulum 5514 is the difference between the pre-rotation disposition 5610 angle 5612 and the post-rotation angle 5712.

A side cross-section view of a representative portion of a third pendulum arm embodiment 5810 of the present invention is depicted in FIG. 58. Among other purposes, the pendulum arm embodiments illustrate the wide range of differing effects available with the variations of the pendulum (and other types of) embodiments which fall within the scope of the present invention. In the third pendulum arm embodiment 5810, pendulum arm 5812 outer ends 5814 of are pivotally connected in front and back pairs to the forward and rearward ends, respectively, of tread segment frameworks 5816. At their upper ends, the pendulum arms 5812 are pivotally connected to a sliding connection 5818 that travels in slots 5820 formed in a suspending layer (not shown), so that as the tread segments encounter the roadway and assume the load of the vehicle, the pendulum arms move from disposition 5822 to disposition 5824 to disposition 5826. As the pendulum arms 5812 rotate through these dispositions, their change in angle relative to the suspending layer can be utilized to drive transitioners (not shown) such as in the first pendulum arm embodiment 5110. Among the benefits of the third pendulum arm embodiment 5810, are its ability to fit the energy harvesting mechanism in a minimal profile height 5828, and a pendulum arm length 5830 that is actually longer than the distance to the suspending layer, so that the geometries of the pivoting connections and, for example, the framework pivots 2536 are able to be overlaying when preferred.

A side cross-section view of a representative portion of a fourth pendulum arm embodiment 5910 of the present invention is depicted in FIG. 59. Differences between the third and fourth pendulum arm embodiments 5810 and 5910, respectively, both illustrate the ranges of variations that fall within the scope of the present invention, but also the types of effects that can be achieved with relatively simple differences. In the fourth pendulum arm embodiment 5910, the pendulum arms are shorter than those in the third pendulum arm embodiment 5810, so that the energy generating pendulum arm 5912 angle change can occur in less space, i.e. quicker also. A slot 5914 is shorter as well to reduce the degree of overlap, as well as being angled more steeply, relative to the suspending layer (not shown) it is formed within. These combinations can also allow a reduced final profile height 5916 (which appears larger than 5828 since the fourth pendulum arm embodiment 5910 is depicted in larger scale than the third pendulum arm embodiment 5810 is depicted in.

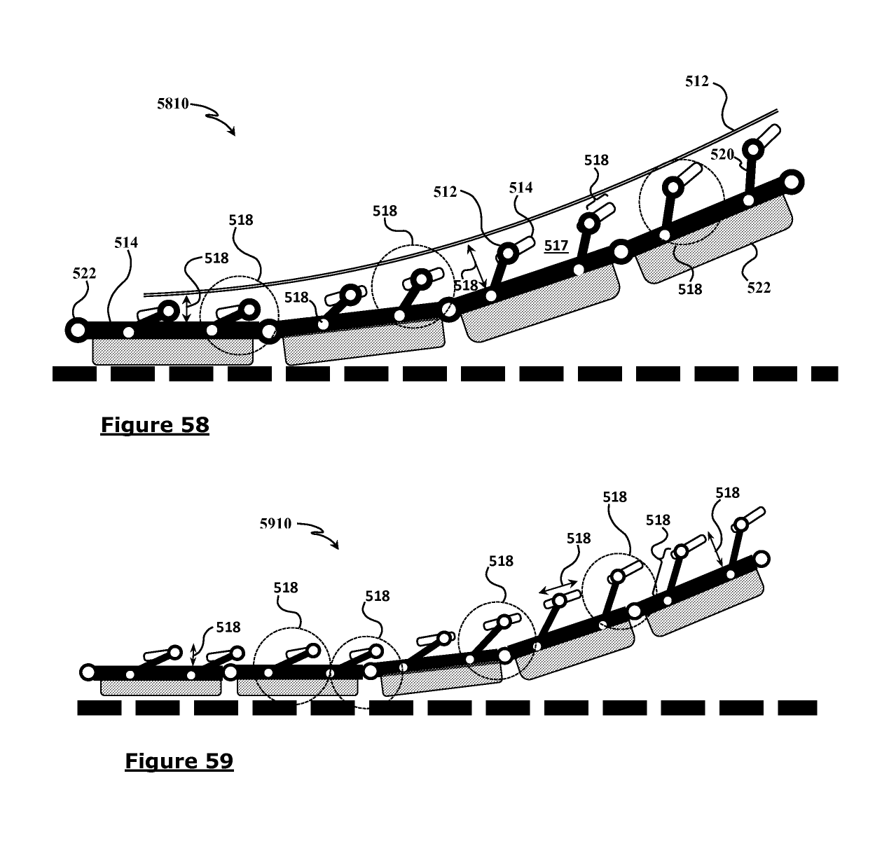

A first dual reverse pendulum embodiment 6010 of the present invention is depicted in side views in extended and compressed dispositions in FIGS. 60a & 60b, respectively. The first dual reverse pendulum embodiment 6010 includes a dual layer construction comprising a lower tread segment 6012 and an upper active layer segment 6014, which are also connected at their ends with pliable sides 6016 to produce a closed interior space. Left and right reverse pendulum arms 6018 and 6020, respectively, prop up the active layer segment 6014 when at the left ends of slots 6022 so that the layers are separated by the height 6024 which can end up almost completely closed when the pendulum upper end pivots 6026 reach the right end of the slots 6022. A framework backing 6028 of the tread segment 6012 supports pivotal connections 6030 from which the reverse pendulums prop up the active layer segment 6014. The pivots 6026 are connected by rotatable couplings 6032 to linear gearings 6034 which drivingly engage with associated gears 6036 that engage with an endless drive belt that drives a central shaft 6038 in a tri-pulley arrangement depicted in expanded detail in FIG. 61. The central shaft 6038 in turn drives a generator 6040. When the tread segment 6012 encounters the roadway and assumes the load of the vehicle, the reverse pendulum arms 6018 are thrust to disposition 6012, so that the upper end pivots 6026 have traveled the distance 6014 to the right, though due to the design choice variation to have the linear gearings on opposite sides of the associated gears 6036 (a design choice whose reverse, both linear gears on the same side of the active layer segment 6014 and the associated gears 6036, also falls within the scope of the present invention.) The harvested drive is transitioned to the generator 6040 via an endless belt 6112 that loops clockwise around the left associated gear 6036, crosses up and down sides as it switches to a 360 degree loop around the central shaft 6038 and then runs straight across to the right associated gear 6036, which the belt 6112 loops around in counterclockwise direction. The belt 6112 then leaves the right associated gear 6036 and heads back to the central shaft for another full loop in the direction 6114. Hence, as the linear gears 6034 are moved back and forth in the directions 6116 by the active layer 6014 closing to and opening up from the tread segment 6012, their effect is transitioned to the central shaft 6038 which in turn drives the generator 6040.

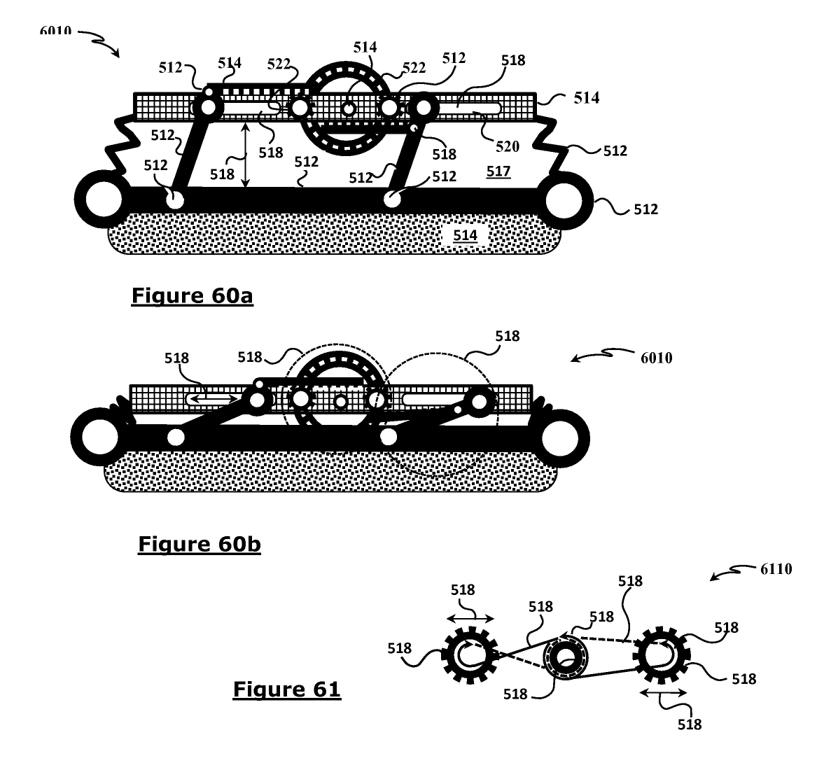

A representative portion of a first slotted pivoting segmented-tread aspect 6210 depicted in side cross-section view in FIG. 62 is suitable for utilization with a first post & reciprocating barrel embodiment 6310 of the present invention that is depicted in side cross-section view in FIG. 63a, in a compressed disposition. A side, cross-section view of a post & reciprocating barrel aspect 6311, which when in the extended disposition is designated as 6311b, and when in the compressed disposition is designated 6311a, is depicted in FIG. 63b. The first slotted pivoting segmented-tread aspect 6210 incorporates tread segment backings 6212 that are interrelated with pivots 6214 that controllably reduce the effect of hysteresis on the deforming of the tire periphery as in present tires. The first post & reciprocating barrel embodiment 6310 is constructed in modular arrangements with a given tread segment 6212 supporting at its pivots 6214 accordioning sides 6314 that connect above with a device framework 6316. When the first post & reciprocating barrel embodiment 6310 is fully compressed, a height of only 6318 remains, which is approximately half of the first post & reciprocating barrel aspect 6311b extended height as seen in FIG. 63b. When encountering the roadway, the left edge of the tread backing 6212 will be forced upward before the right edge is. Hence, the tread backing 6216 will initially move clockwise, while the device framework 6316 will be relatively stationary; and later, when the left first post & reciprocating barrel aspect 6311 reaches (or approaches) its 6311a disposition, the right side of the tread backing 6212 will tend to move counterclockwise, while the device framework 6316 will be substantially more stationary.

Pairs of slots 6216 enable limited amounts of forward and backward movement of the rolling (or other friction reduction,) interconnections 6312, which thereby enable the strictly linear direction of movement 6318 of the axis of rotation about the first post 6320 by the first reciprocating barrel 6322. The first post & reciprocating barrel aspect 6311, though constrained to compress and expand strictly in the direction 6318, needs also for its interconnection 6312 to be anchored in a tread backing 6212 that primarily moves in arcs relative to the device framework 6316. The first post 6320 has upward spiraling first grooves 6324 incised into its periphery which receive mated first projections 6326 that project from the interior surface of the first barrel 6322, with the interaction of the first projections 6326 and the first grooves 6324 being selectively variable, with variations in friction, dimensions, and interaction factors all falling within the scope of the present invention. As the first post 6320 is thrust into the first barrel 6322 by contact with the roadway, the first barrel is spun about its longitudinal axis, which can be used to drive a generator or a one or more transitioners, disposed within the device framework 6316, for example, that transition the power to a generator. An axial flux generator could be a design of substantial utility in this scenario, with a rotor portion of such a generator driven to turn by the first barrel 6322, and in this case would be disposed in the upper edge and/or top of the first barrel 6322.

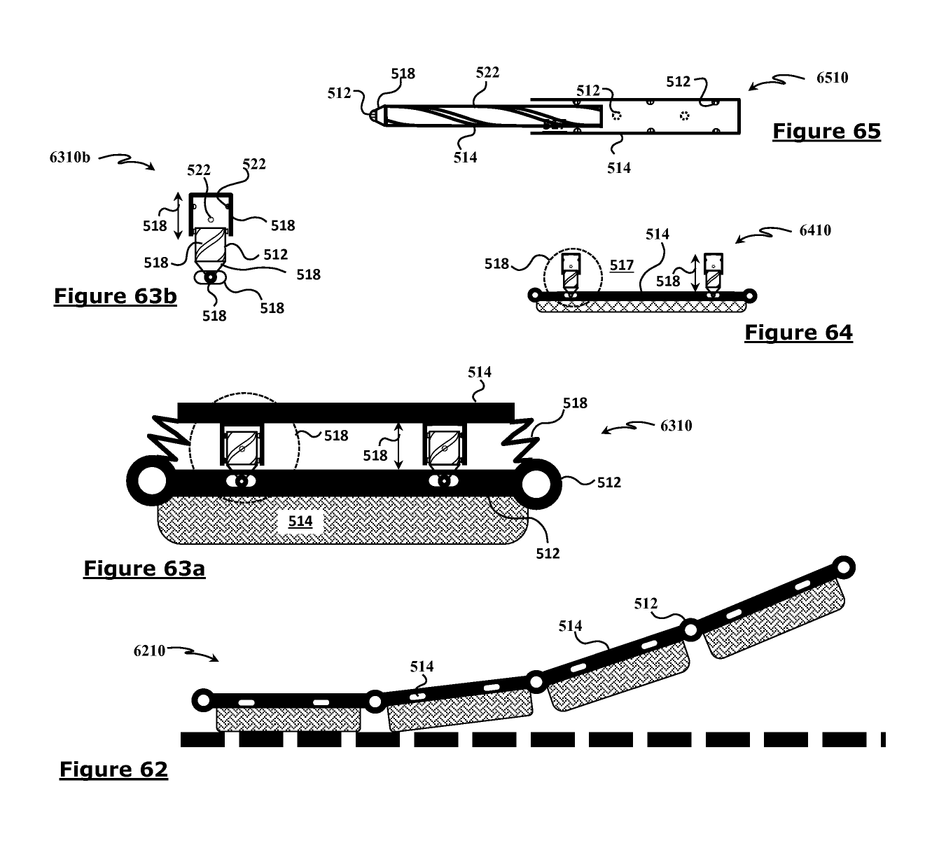

Wide ranges of variations in the particulars details of the post & reciprocating barrel embodiments of the present invention are within the scope of the present invention, and the examples illustrated and/or described are not limiting. Among these variations are (1) posts having the projections and barrels having the grooves; (2) posts and barrels having differing forms of mating interrelations that allow similar manners of relative movement; (3) posts being the rotating element within non-rotating barrels; (4) disposing slots 6216 in the device framework 6316; (5) differing forms of linear/arcuate motion compensation such as a short pivoting arms, or other manners of multi-part substitutes for the interconnection 6312. Other variations include wide adaptability in many forms of the dimensional relationships among the constituent components of a post & reciprocating barrel embodiment. A cross-section side view of a tread and transitioner portion of a second post and reciprocating barrel embodiment 6410 is depicted in FIG. 64. Illustrated in the seam scale as, and as a contrast to the first post & reciprocating barrel embodiment 6310, the second post & reciprocating barrel and embodiment 6410 has similar, but substantially smaller post & reciprocating barrel aspects 6412, as well as a much lower and smaller profile tread segment 6414. The second post & reciprocating barrel aspect 6416 has an extended height 6416 that is substantially more than the depth of tread segment 6414, though this dimension can be varied, including with a much shorter and circumferentially wider (not shown) post & reciprocating barrel. This variant could be a widely applicable solution in many very low profile circumstances. The angle of the grooves can also be widely varied. When the grooves are angle more horizontally than vertically, more resistance to compression can result, which may be advantageous in certain circumstances. When the grooves are angled more upward than sideways, the post & reciprocating barrel will initiate rotation faster with less resistance, which may also be advantageous in certain circumstances. Embodiments with sideways dispositions, as well as those that are elongated, also lie within the scope of the present invention, as FIG. 65 depicts in an expanded detail cross-section view of a third post and reciprocating barrel transitioner aspect 6510.

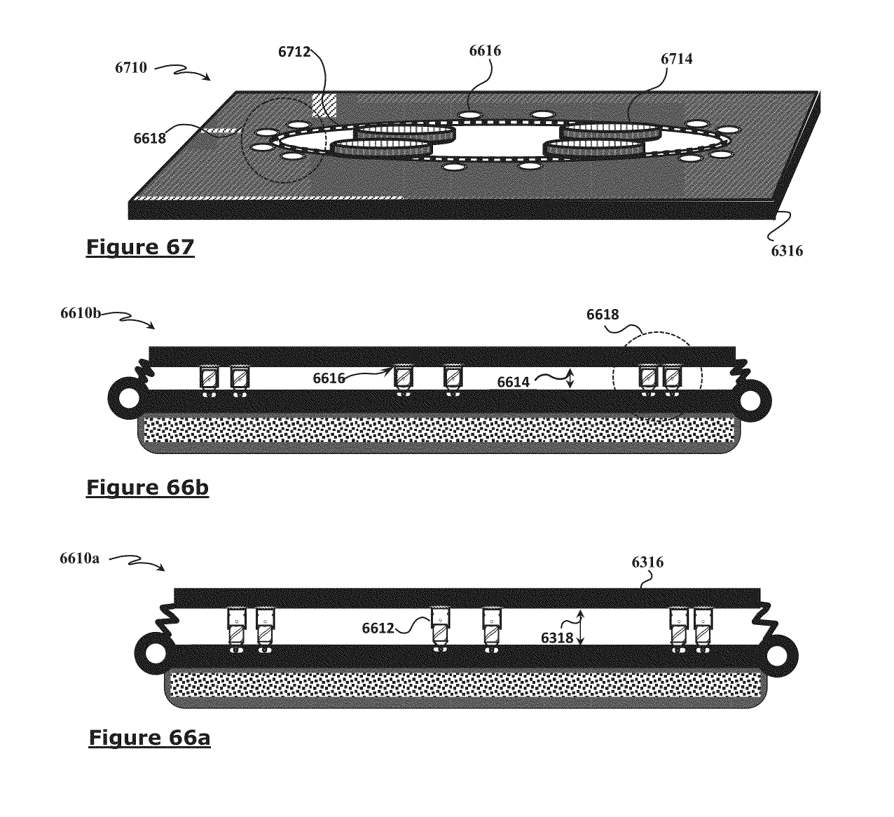

Side cross-section views of a fourth post and reciprocating barrel embodiment 6610 is depicted in extended pre-work phase and compressed post-work phase dispositions in FIGS. 66a & 66b, respectively. In addition to further demonstrating another example of the wide range of alterations in the types and varieties of dimensional attributes of the post & reciprocating barrel embodiments that fall within the scope of the present invention, potential benefits in types of deployment and approaches to power gathering are presented by the fourth post & reciprocating barrel embodiment 6610. Among the noteworthy characteristics of the fourth post & reciprocating barrel embodiment 6610 are its low profile height 6318 (or 6614 for when compressed,) as well as its utilization of a plurality of compact post & reciprocating barrel aspects 6612. At the top ends of these compact post & reciprocating barrel aspects 6612 are gearings 6616 that are concentric with the periphery of the top end of the barrel of the fourth post & reciprocating barrel aspect 6612, and whose plane of rotation is within the plane of the device framework 6316. An elevated perspective view of a portion of a first multi-geared transitioner arrangement 6710 suitable for inclusion in the fourth post and reciprocating barrel embodiment 6610 is depicted in FIG. 67 of the present invention. A grouping 6618 of the gearings 6616 are arranged on the periphery of an inset planetary gear 6712 incorporated within device framework 6316. Additional groupings of the gearings 6616 and individual gearings 6616 are also arranged about the planetary gear (i.e. transitioner) 6712 which in turn can translate its power to transfer gears 6714 which can in turn collectively drive an interior gear (not shown for clarity, but essentially identical to and disposed in plane with and between the transfer gears 6714,) which in turn can drive a generator directly as the “collector” of the power form all of the compact post & reciprocating barrel aspects 6612.

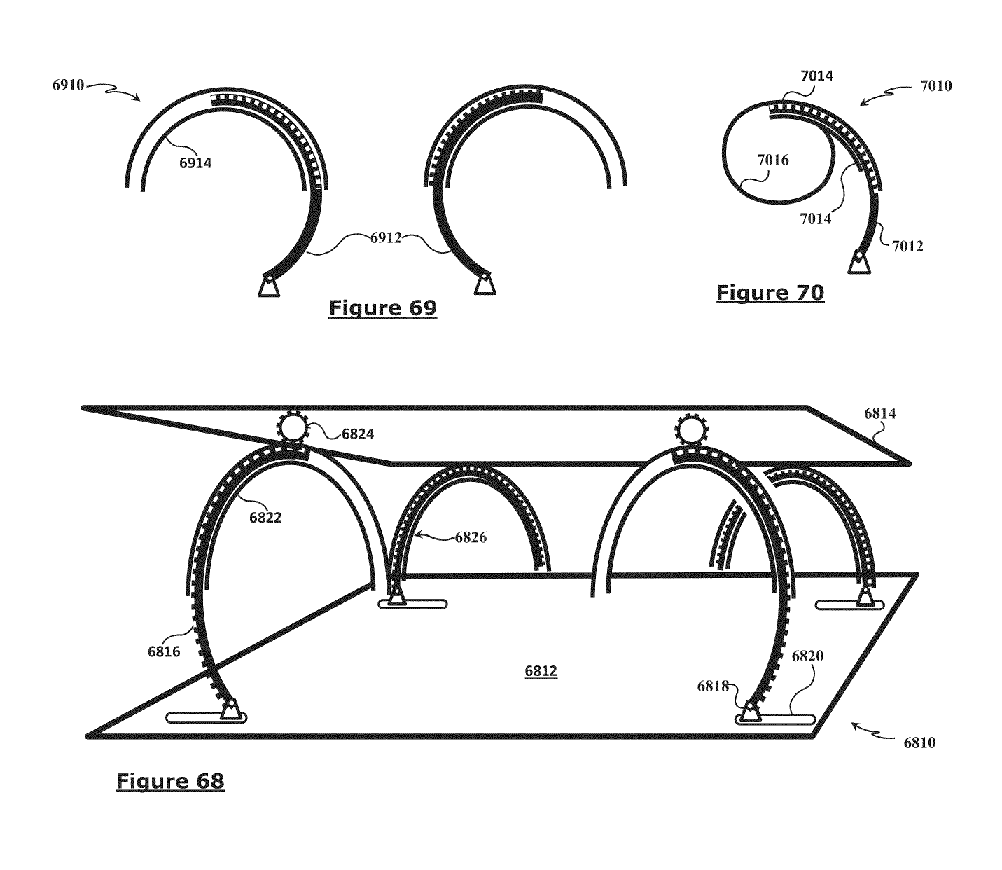

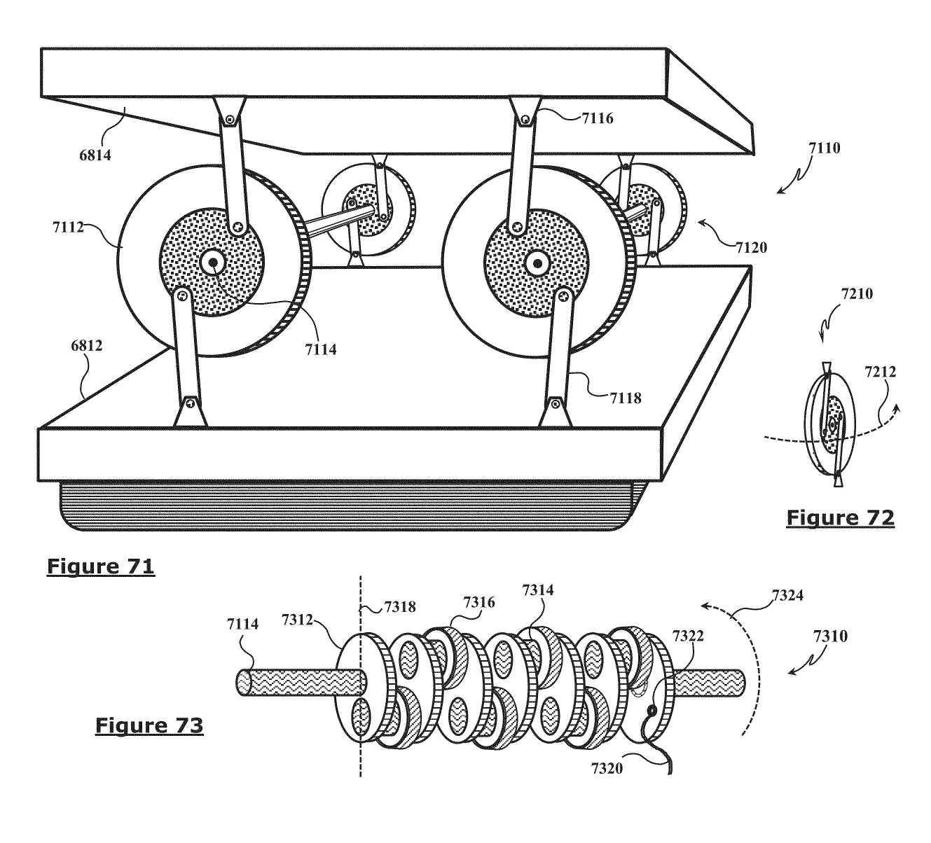

A perspective segmented-tread interior view of a first sleeved gearing embodiment 6810 is FIG. 68 wherein the rear of FIG. 68 is the portion of the dual-layer segmented-tread interior 6812 that is already being compressed by contact with the roadway, while the interior lower tread backing layer 6812 is still primarily extended before being driven upward towards the inward layer 6814. An arcuate gearing 6816 is pivotally connected below to anchor 6818 that can slide laterally in slot 6820. A channel 6822 guides and constrains the arcuate gearing 6816 so that it drives the transfer gear 6824 which in turn transitions the power generated to eventual electricity generation. The post-compression disposition 6826 of the arcuate gearing 6816 and channel 6822 demonstrate that the return stroke process may be enhanced by appropriately connecting (not shown) an appropriate portion of the arcuate gearing 6826 to the tread segment layer 6812.

A side cross-section view of a second transitioner aspect portion 6910 suitable for use within the dual-layer segmented-tread. While in the first sleeved gearing embodiment 6810, the arcuate gearings 6816 are capable of flexing, so that they do not have to be circular, in the second transitioner aspect portion 6910 the arcuate gearings 6912 are circular and rigid, so that their transition through the channel 6914 may be facilitated by reduced friction within the interior of channel 6914. A spiral sleeved gear aspect 7010 is depicted in a side cross-section view in FIG. 70. A flexible arcuate gearing 7012 is guided and constrained by channel 7014 that evolves into a spiraling inward reducing radius extension 7016, which enables the utilization of the spiral sleeved gear aspect 7010 in substantially smaller compressed profile circumstances.

A perspective view of a first reciprocating cam embodiment 7110, disposed within the interior of an dual-layer tread segment in the midst of compression, is depicted in 71. A sequence (two are shown, more are within the scope of the present invention,) of cams 7112 that drive, via one-way gearings (not shown), a driveshaft 7114 that is shown disposed front to back but it should also be understood that other dispositions of the cams 7112 and drive shaft 7114, such as side to side, are also within the scope of the present invention. Anchors 7116 pivotally connect with drive arms 7118 that are in turn pivotally connected to the cams 7112. The differences in the arrangement of the parts of the cams and their connections caused by the contact with the roadway are seen by inspection of the post-compression disposition 7120. It is also within the scope of the present invention for the cam arrangements to be disposed differently, such as in the rotated disposition 7210 wherein the cams are turned by the angle 7212.

A perspective view of a second reciprocating cam aspect 7310 is depicted in FIG. 73, which is also suitable for analogous types of utilization as the first reciprocating cam embodiment 7110. A series of rotational axis sharing cams 7312 are disposed along driveshaft 7114. Each successive pair of cams are interconnected eccentrically with dowels 7314 that are less than half of the diameter of the cams 7312. The dowels 7314 are disposed in alternating arrangements, 180 degrees apart, so that the first and second cam are connected, as shown, at their bottom portion, while the second and third are connected at their top portion, the third and the fourth are connected at their bottom portion, and so on. Arranged about the dowels 7314 are contact rings 7316 that are pressed on by the internal surfaces of the dual-layer segmented-tread that the first reciprocating cam embodiment 7110 is disposed within. The contact rings 7316 are arranged on opposite sides of the cams 7312 along the bisecting line 7318, so that the action of the second reciprocating cam aspect 7310 is defined by the orientation of the line 7318. The degree of motion possible is determined, at least in part, by the relative dimension of the contact ring 7316 relative to the cam 7312, and to the closeness to the periphery of the cam 7312 at which the center of rotation of the contact ring 7316 is disposed. In use, normally, the line 7318 will be rotated approximately 45 degrees about the axis of rotation of the driveshaft 7114, in the direction of arrow 7324, with a degree of reciprocating movement about its center position. A tether 7320 is attached to the associated closer internal layer of the dual-layer segmented-tread and to the associated layer of the dual-layer segmented-tread, with its attachment 7322 to cams 7312 chosen so that when the dual layer segmented-tread is compressed, the tether 7320 is pulled taught, while when in the disposition to start compression, the tether is relatively slack.

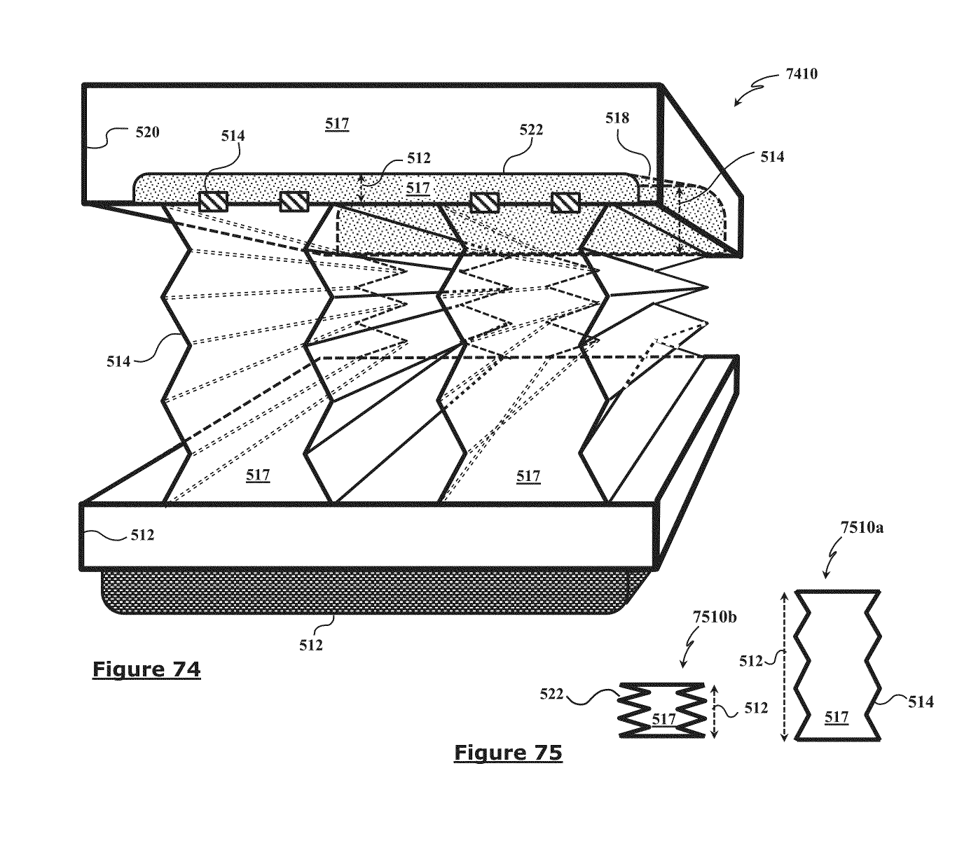

A first bellows embodiment 7410 is depicted in perspective, partial second view in FIG. 74, shown in a disposition seen when it is undergoing compression due to contact with the roadway, for example. A pair of left and right bellows 7411 are disposed in longitudinally extending arrangements, though essentially any multitude of bellows, shapes, combinations, orientations, and/or arrangements are also with the scope of the present invention. The interior 7412 of the bellows 7411 is filled with a fluid, either gas or liquid, though even a combination may be advantageous in certain circumstances. As seen in FIG. 74, the rear portion of the first bellows embodiment 7410 has been substantially compressed already while the front portion has not yet (in reality, this great of a difference may not be possible in operation, but it is presented herein as a means of explication with greater clarity. The fluid within the interior 7412 is driven by the compression through the transitioners and/or transducers 7414 which can be, for example impellers or ducted airways driving directly or indirectly energy harvesting operations. The fluid enters an above chamber 7414 which expands in height to 7416 from 7418 by the influx of the fluid. Obviously, the simplicity and ease of deployment of the first bellows embodiment 7410 enables it to fulfill a number of other tasks, in addition to tires. Extended 7510a and compressed 7510b disposition cross-section views of the first bellows 7411 are depicted in FIG. 75. The difference in height 7512 of the extended bellows compare to the height 7514 of the compressed bellows demonstrates the energy harvesting potential of this embodiment, which may be sufficient to outweigh the relative inefficiencies of fluid flow energy capture in many cases.

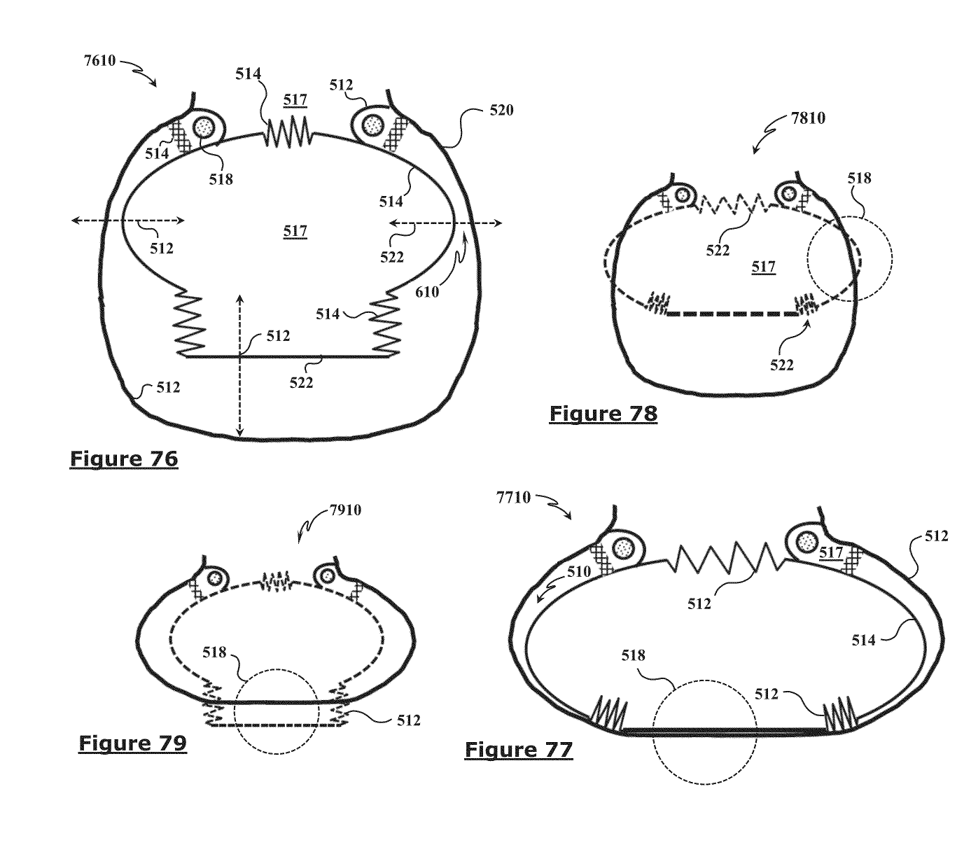

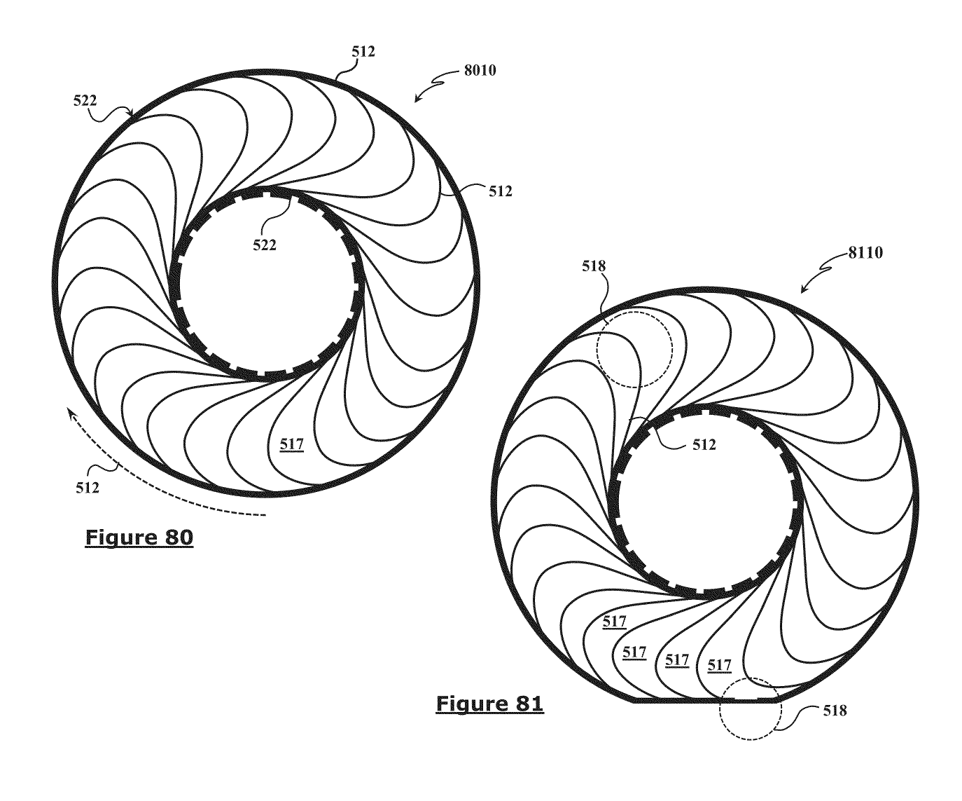

A cross-section view of a first internal shape-shifting pressurizer embodiment 7610 is depicted in cross-section view in FIG. 76, in a non-load bearing disposition. Within the tire interior 7612 is a shape-shifting pressurizer aspect 7614 that consists of outwardly bulging, relative stiff side walls 7616 that are interconnected at the upper edge by a flexing bridge 7618 which can expand and contract. A relatively stiff bottom wall 7620 spans much of the transverse space of the interior 7612 and is interconnected at its outside edges with flexing skirts 7621 to the bottom edges of the side walls 7616, so that the pressurizer interior 7622 is a sealed space within the tire interior 7612, and separated so that the two interiors are unable to exchange air. A series of radially radiating transversely dividing separations (not shown, but similar in nature to those seen in FIG. 15, though potentially differing in number and disposition,) are arranged parallel to the plane of FIG. 76, so that each transverse subdivision is outfitted with a separately operating shape-shifting pressurizer aspect 7614. As seen in FIG. 79, the tire interior's loaded arrangement 7910 doesn't allow the uncompressed arrangement of the shape-shifting pressurizer aspect 7614. As the tire interior gets vertically compressed, the bottom wall 7620 is thrust upward in the direction 7624 by contact 7712 with the tire interior bottom surface, so that the pressurizer interior 7622 is compressed until its interior pressure is greater than the tire interior, which thrusts the side walls 7616 into a wider disposition 7616b. In the non-load bearing disposition, the interior side space 7626 between the tire internal side surface and the side wall 7626 is reduced to the squeezed space 7626b when this section of tire is bearing the load of the vehicle. The reduction in space drives the air that was within the space 7626 through a pair of transitioners (and/or transducers, such as impellers, etc.,) 7628, after which it may be shunted by ducts 7630 to another subdivision of the tire which can be converted by the influx of air form the disposition of FIG. 77 back to the disposition of FIG. 76.

Side cross-section views of a first rotating partitions embodiment 8010 of the present invention, is depicted in FIG. 80 in a non-load bearing disposition and is depicted in FIG. 81 in a load bearing disposition. throughout the interior of the tire a plurality of rotating partitions 8012 are radially arranged, with a relatively similar amount of air within each partition defined subspace 8014 that is generally airtight. The partitions 8012 are shown in one orientation, which will produce counterclockwise travel of the partitions 8012, though they can be configured as essentially mirror images, in which they would travel clockwise. The exact shapes of the partitions are also variable depending on the circumstances of utilization. The shape 8112 illustrated is not intended to be limiting, but is chosen since it is expected to produce substantial effects of usable thrust. The partitions 8012 are able to move freely in the clockwise direction about the tire interior, with their exterior connection being a relatively airtight but smoothly sliding interconnection 8016, and wherein the construction of the interconnection 8016 and the partitions 8012 is relatively stiff, but pliable enough to accommodate the changes in shape of the tire interior when being loaded without comprising the airtightness of the interconnection 8016. At its internal end, the barrier 8012 terminates in a relatively straight line (for mechanical efficiency) connection 8018 to a mechanical transitioner/transducer 8020. As the contact patch 8114 flattens a portion of the tread and compresses the portion of the tire bearing the vehicle load, the sub-space 8116 between the partitions gets squeezed. The partitions 8020 are free to move in only the clockwise direction, so that the partition 8020 immediately to the left of the sub-space 8116 is forced to move clockwise by the increased air pressure in sub-space 8116, and in turn applying power via its connection 8018 to the transitioner/transducer 8020.

In view of the above, it will be seen that the various objects and features of the invention are achieved and other advantageous results obtained. The examples contained herein are merely illustrative and are not intended in a limiting sense.

What is claimed is:

1. An energy harvesting interface surface, comprising:
a contact interface surface, characterized by,
said interface having at least a first segment, wherein, over a span of contact event occurrences that includes at least one non-occurrence, the first segment encounters a first set of contact forces when the contact event is occurring and encounters a second set of contact forces when the contact event is not occurring, said first and second sets of contact forces producing differing first and second first segment dispositions; and
at least a first transducer driving mechanism interrelated with the first segment, wherein alteration of the disposition of the first segment between the first and second dispositions is harnessed by the at least a first transducer driving mechanism as a power input.

2. An energy harvesting interface surface according to claim 1, further comprising:
the contact interface surface of claim 1, further characterized by,
said interface further having at least a second segment, wherein, over the span of contact event occurrences, when one of the segments is encountering one of the set of contact forces, the other segment is encountering the other set of contact forces, said first and second sets of contact forces also producing the differing first and second segment dispositions of the second segment.

3. An energy harvesting interface surface according to claim 1, further comprising:
the contact interface surface of claim 1 being an inflatable toroidal surface structure enclosing a pressurizable air volume and having an exterior roadway contact interface surface, suitable for disposition on a vehicle wheel as a rolling support tire, further characterized by,
said first and second segments being angularly separated in their respective arrangements about the axis of the toroidal surface structure.

4. An energy harvesting interface surface according to claim 3, wherein the segmented inflatable toroidal surface structure of claim 4 is further characterized by:
the segments' differing first and second disposition producing differing first and second pneumatic pressures, and said difference in first and second pneumatic pressures is the first transducer mechanism's power input.

5. An energy harvesting interface surface according to claim 4, further characterized by the differing first and second pneumatic pressures driving the first transducer driving mechanism by forcing a partition in the direction of higher to lower pressure.

6. An energy harvesting interface surface according to claim 4, further characterized by the differing first and second pneumatic pressures driving the first transducer driving mechanism by producing an airflow in the direction of higher to lower pressure that is channeled through at least a portion of and thereby drives the first transducer driving mechanism power input.

7. An energy harvesting interface surface according to claim 3, further characterized by said first and second segments being sub-divisions of a substantial portion of a tread portion of an inflatable tire.

8. An energy harvesting interface surface according to claim 3, further characterized by said first and second segments being subdivisions of a substantial portion of a tire's inflatable interior space.

9. An energy harvesting interface surface according to claim 7, further characterized by a substantial portion of a tire's inflatable interior space being subdivided as internal first and second segments, and a substantial portion of a tread portion of an inflatable tire being subdivided as tread first and second segments.

10. An energy harvesting interface surface according to claim 8, further characterized by inclusion of at least a first shape shifting pressurizer disposed within each segment subdivision of a tire's inflatable volume, wherein said inflatable volume segment assumes a first cross-section when encountering a first set of contact forces, and assumes a second cross-section when encountering a second set of contact forces, said first and second cross-sections forcing the shape shifting pressurizer to assume first and second configurations, respectively, wherein the percentage of the segment's interior air volume exterior of the shape-shifting pressurizer is substantially less when the segment is assuming the first cross-section than when it is assuming the second cross-section.

11. An energy harvesting interface surface according to claim 8, further characterized by said inflatable volume segment assuming a first cross-section when encountering a first set of contact forces, and assuming a second cross-section when encountering a second set of contact forces, and the transition between the first and second cross-sections drive at least one of the first and a second transducer mechanism.

12. An energy harvesting interface surface according to claim 7, further characterized by said tread segments having interconnections that allow the tread segments to alter relative orientations with less resistance than the tread segments themselves, said interconnections including flexes, pivots and articulations.

13. An energy harvesting interface surface according to claim 7, further characterized by said tread segments comprising at least a first active layer, said first active layer expressing at least a portion of said first and second segment disposition differences to provide, directly or indirectly, the power input for the first transducer driving mechanism.

14. An energy harvesting interface surface according to claim 7, further characterized by said tread segments comprising at least first and second active layers, wherein disposition differences between the first and second active layers expresses at least a portion of said first and second segment disposition differences to provide, directly or indirectly, the power input for the first transducer driving mechanism.

15. An energy harvesting interface surface according to claim 13, further characterized by a substantial portion of the tire's inflatable interior space being subdivided as internal first and second segments, wherein disposition differences between the first and second internal segments expresses at least a portion of said first and second internal segment disposition differences to provide, directly or indirectly, the power input for at least one of the first and a second transducer driving mechanism.

16. A rolling support construction, comprising an inflatable toroidal surface structure enclosing a pressurizable air volume and having an exterior roadway contact interface surface, suitable for disposition on a vehicle wheel as a rolling support tire, characterized by:
said contact interface surface comprising a plurality of tread segments having interconnections that allow the tread segments to alter relative orientations with less resistance than the tread segments themselves, said interconnections including flexes, pivots and articulations.

17. A contact interface support for intermediating recurrently occurring and recurrently non-occurring contact forces, configurable as a surface or a cushion element, comprising at least one support segment, characterized by at least one active layer, said active layer assuming at least first and second dispositions in response to first and second sets of contact forces, respectively, wherein said active layer, in transitioning between said first and second dispositions is harnessed as a power input for a transducer driving mechanism.

18. The contact interface support for intermediating recurrently occurring and recurrently non-occurring contact forces, configurable as a surface or a cushion element, comprising at least one support segment according to claim 17, wherein the first and second dispositions produce pneumatic power as the input for a transducer driving mechanism.

19. The contact interface support for intermediating recurrently occurring and recurrently non-occurring contact forces, configurable as a surface or a cushion element, comprising at least one support segment according to claim 17, wherein the first and second dispositions produce hydraulic power as the input for a transducer driving mechanism.

20. The contact interface support for intermediating recurrently occurring and recurrently non-occurring contact forces, configurable as a surface or a cushion element, comprising at least one support segment according to claim 17, wherein the first and second dispositions produce mechanical power as the input for a transducer driving mechanism.
